(19) United States
(12) Patent Application Publication
(10) Pub. No.: US 2015/0347644 A1
(43) Pub. Date: Dec. 3, 2015

(54) DESIGNING APPARATUS AND DESIGNING METHOD

(71) Applicant: SOCIONEXT INC., Yokohama-shi (JP)

(72) Inventors: Toshio ARAKAWA, Hachioji (JP); Yoshinori Yamagata, Kawasaki (JP)

(21) Appl. No.: 14/721,770

(22) Filed: May 26, 2015

(30) Foreign Application Priority Data
May 27, 2014 (JP) 2014-108959

(51) Int. Cl. G06F 17/50

(52) U.S. Cl. CPC G06F 17/505

(57) ABSTRACT

A designing apparatus generates a logic cone and calculates an area ratio between a first triangle and a second triangle. The first triangle has a logic cell as an angle in an m-th stage between input and output stages and input-side FFs as the other angles at both ends of the input stage, the FFs connected to input of the cell. The second triangle has an output-side FF as an angle in the output stage and logic cells as the other angles at both ends of the m-th stage, the cells connected to input of the FF in the output stage. The apparatus sets, when the ratio matches a predetermined ratio, a first logic cone block between the input and m-th stages and a second logic cone block between the output and m-th stages as logic synthesis units and performs logic synthesis by using the logic synthesis units.

### CROSS-REFERENCE TO RELATED APPLICATION

This application is based upon and claims the benefit of priority of the prior Japanese Patent Application No. 2014-108959, filed on May 27, 2014, the entire contents of which are incorporated herein by reference.

### FIELD

The embodiment discussed herein relates to a designing apparatus and a designing method.

### BACKGROUND

In the field of designing semiconductor integrated circuits, there is a technique in which logic synthesis (logic design) and wiring arrangement (physical design) are performed. In this technique, first, the logic synthesis is performed by using register transfer level (RTL) design data, and next, wiring arrangement for arranging and connecting cells is performed by using a netlist generated by the logic synthesis. In the logic synthesis, the netlist is generated in view of timing, the total cell area of the circuit unit, and so forth. See, for example, the following document:

Japanese Laid-open Patent Publication No. 2007-115159

In the above logic synthesis and wiring arrangement, even if the total cell area of the circuit unit is small at the logic synthesis stage, wiring congestion could occur at the wiring arrangement stage, depending on the type of the circuit unit. If the circuit density is decreased in order to reduce wiring congestion, the layout area could be increased. If the logic synthesis and the wiring arrangement are repeated in order to set a logic synthesis unit that reduces the chance of the occurrence of wiring congestion and the increase of the layout area, the efficiency in designing the semiconductor integrated circuit could be decreased.

### SUMMARY

According to one aspect, there is provided a designing apparatus including: a processor configured to perform a procedure including: generating a logic cone; calculating an area ratio between a first triangle, which has a cell as an angle located in a certain stage between an input stage and an output stage in the logic cone and two cells as the other angles located at both ends in the input stage, each of the two cells being connected to an input of the cell located in the certain stage, and a second triangle, which has a cell as an angle located in the output stage and two cells as the other angles located at both ends in the certain stage, each of the two cells being connected to an input of the cell located in the output stage; setting, when the area ratio matches a desired ratio, a first logic cone block between the certain stage and the input stage and a second logic cone block between the certain stage and the output stage as logic synthesis units; and performing logic synthesis by using the logic synthesis units.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating a designing method;

FIG. 2 illustrates an example of a designing apparatus;

FIG. 3 illustrates an exemplary configuration of the designing apparatus;

FIGS. 4 to 6 illustrate an exemplary logic synthesis flow;

FIGS. 7 to 22 illustrate exemplary logic synthesis subflows (SF1 to SF16), respectively;

FIGS. 23 to 35 are explanatory diagrams 1 to 13, respectively, illustrating the logic synthesis flow;

FIGS. 36A to 36C are explanatory diagrams 14 illustrating the logic synthesis flow;

FIGS. 37A and 37B illustrate wiring congestion evaluation results;

FIGS. 38 and 39 illustrate exemplary circuits 1 and 2, respectively; and

FIG. 40 illustrates an exemplary hardware configuration of a computer.

### DESCRIPTION OF EMBODIMENTS

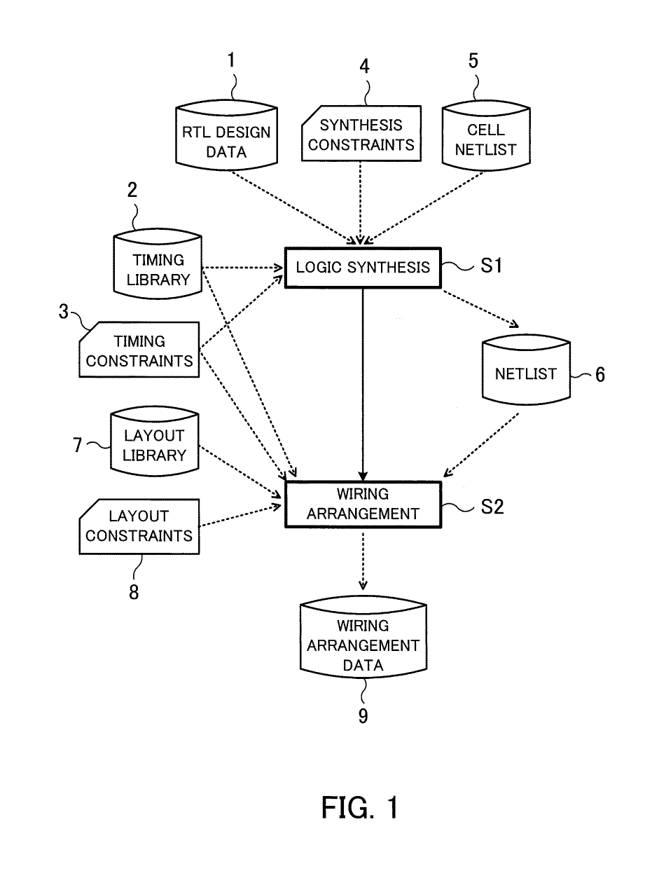

FIG. 1 is an explanatory diagram illustrating a designing method. This explanatory diagram illustrates a logic synthesis step (step S1) and a wiring arrangement step (step S2) for designing a semiconductor integrated circuit.

In the logic synthesis step (S1), logic synthesis is performed by using information included in RTL design data 1, a timing library 2, timing constraints 3, synthesis constraints 4, and a cell netlist 5.

The RTL design data 1 is RTL data describing logic of a design-target semiconductor integrated circuit. Timing Information used in the logic synthesis and wiring arrangement is stored in the timing library 2. Various timing-related conditions that need to be satisfied in the logic synthesis and the wiring arrangement are registered in the timing constraints 3. For example, the timing constraints 3 include conditions about virtual wiring delays, delay time, clock cycles, input delay values, and output delay values. Various conditions about the logic synthesis are registered in the synthesis constraints 4. For example, the synthesis constraints 4 include conditions about logic synthesis units (logic synthesis scales), the number of usable circuit components for each circuit type, the total logic cell area (logic area) of a circuit unit (function block), clock cycles, semiconductor technology, and wiring layer structures. Connection information about logic cell components such as transistors used in a design-target semiconductor integrated circuit is stored in the cell netlist 5. For example, information about the number of transistors included in a logic cell and the number of input terminals and the number of output terminals of a logic cell is acquired from the cell netlist 5.

Logic synthesis is performed based on the above information, and a gate-level netlist 6 is generated consequently.

In the wiring arrangement step (S2), wiring arrangement is performed by using the netlist 6 generated by the logic synthesis and information included in the timing library 2, the timing constraints 3, a layout library 7, and layout constraints 8.

Information about the size (horizontal and vertical sizes), area, and structure (the layout of the inside of a logic cell, the arrangement of terminals, etc.) of the logic cell, such as a standard cell and a macro cell, is stored in the layout library 7. Various layout-related conditions that need to be satisfied in the wiring arrangement are registered in the layout constraints 8. For example, the layout constraints 8 include conditions about arrangement regions, wiring regions, wiring widths, and spacing.

The wiring arrangement processing is performed based on the above information, and wiring arrangement data 9 is generated consequently.

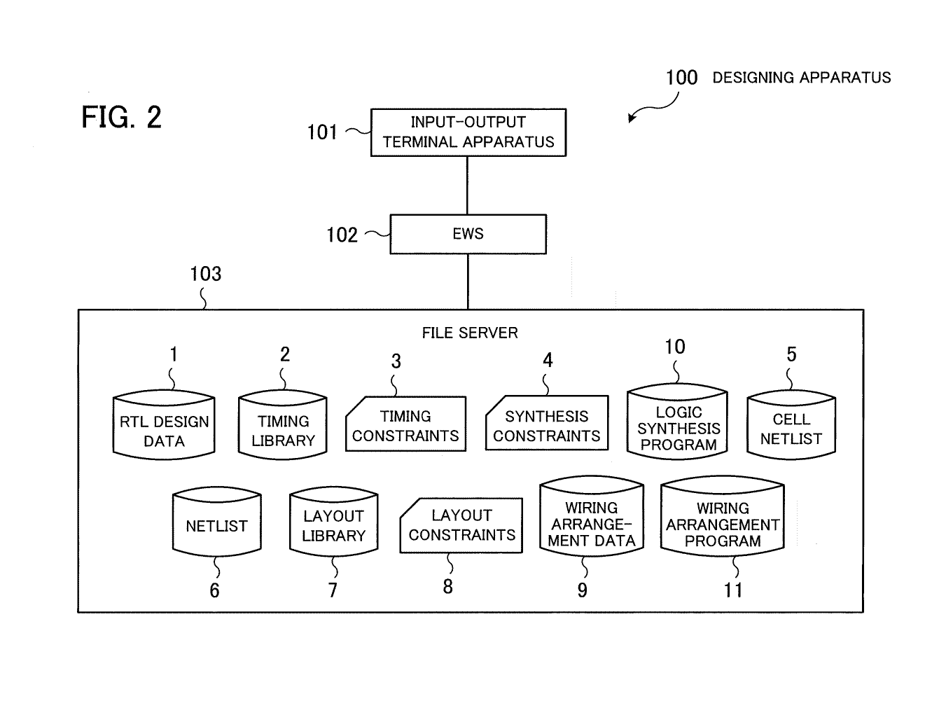

A designing apparatus 100 as illustrated in FIG. 2 performs the logic synthesis and wiring arrangement as described above.

FIG. 2 illustrates an example of the designing apparatus 100.

The designing apparatus 100 illustrated in FIG. 2 includes an input-output terminal apparatus 101, an engineering work station (EWS) 102 connected to the input-output terminal apparatus 101, and a file server 103 connected to the EWS 102. A plurality of input-output terminal apparatuses 101 may be connected to the EWS 102.

The RTL design data 1, the timing library 2, the timing constraints 3, the synthesis constraints 4, the cell netlist 5, the layout library 7, and the layout constraints 8 are stored in the file server 103. In addition, a logic synthesis program 10 used for performing logic synthesis processing and a wiring arrangement program 11 used for performing wiring arrangement processing are stored in the file server 103. In addition, the netlist 6 generated by the logic synthesis and the wiring arrangement data 9 generated by the wiring arrangement are stored in the file server 103. The file server 103 may be configured by a group of servers each holding predetermined information.

In the designing apparatus 100, various information stored in the file server 103 is used on the basis of input from the input-output terminal apparatus 101. In addition, logic synthesis processing and wiring arrangement processing in accordance with the logic synthesis program 10 and the wiring arrangement program 11, respectively, are performed with the EWS 102. The designing apparatus 100 causes the input-output terminal apparatus 101 to display information used in the logic synthesis and wiring arrangement processing and information acquired as a result of each of the processing on a display device such as a monitor.

In the designing apparatus 100, the input-output terminal apparatus 101, the EWS 102, and the file server 103 operate in cooperation with each other to perform the logic synthesis and wiring arrangement processing. The designing apparatus 100 functions as a logic synthesis tool and a wiring arrangement tool.

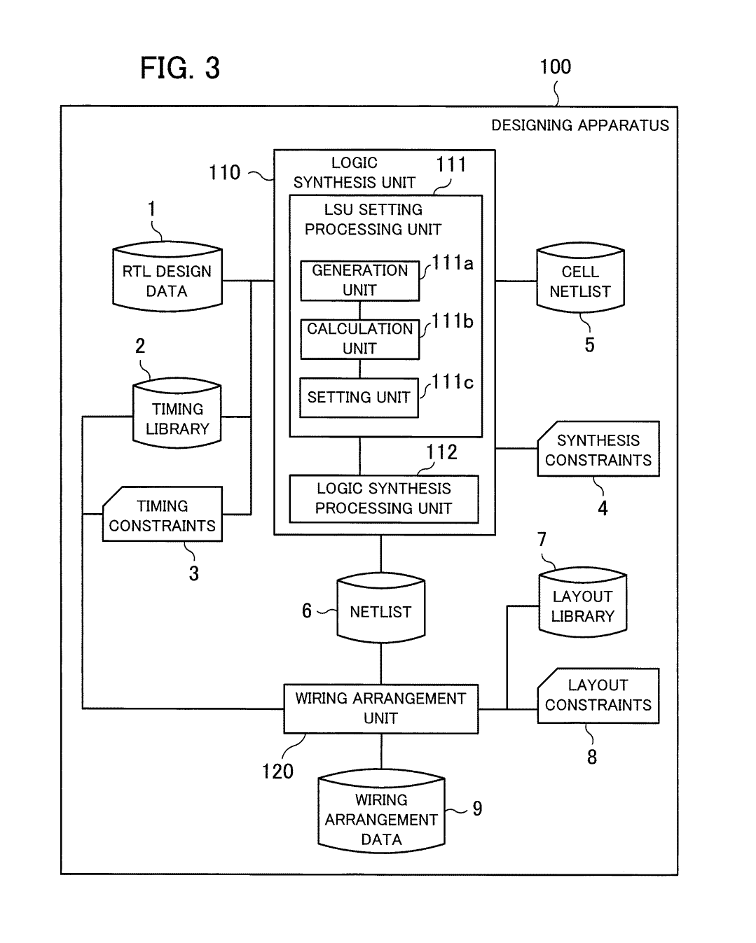

A configuration of the designing apparatus 100 will be described in detail with reference to FIG. 3.

FIG. 3 illustrates an exemplary configuration of the designing apparatus 100.

The designing apparatus 100 includes a logic synthesis unit 110 and a wiring arrangement unit 120. The logic synthesis unit 110 includes a logic-synthesis-unit (LSU) setting processing unit 111 and a logic synthesis processing unit 112. The LSU setting processing unit 111 includes a generation unit 111a, a calculation unit 111b, and a setting unit 111c.

The generation unit 111a generates a layout that includes a logic cone (also referred to as a “cone”) formed by predetermined logic cells by using information in the RTL design data 1 and the cell netlist 5. The generation unit 111a generates the logic cone by using predetermined types of logic cells each having a basic logic structure such as a NAND gate, a NOR gate, an inverter, a 2-input 1-output selector, a flip-flop (FF), etc. The generation unit 111a generates a first layout that includes the logic cone.

The logic cone is a logical block which is configured by a plurality of logic cells logically connected with each other and which has an approximately triangular shape with FFs that serve as angles. Such a logical block is called a logic cone from the similarity in shape between a lateral view of a cone and a triangle.

For example, the generation unit 111a performs logic synthesis on logic cells each having a basic logic structure by using information in the RTL design data 1 and arranges the synthesized logic cells on a grid. The size of a logic cell (the number of squares occupied by a logic cell on the grid) is determined on the basis of information acquired from the cell netlist 5, such as information about the number of transistors and the number of input or output terminals. Alternatively, the size of the logic cell may be set to a predetermined size. To generate a logic cone, the generation unit 111a first arranges an output-side logic cell such as an FF and next sequentially connects other logic cells to the output-side logic cell on the grid in accordance with a certain rule until input-side logic cells such as FFs are connected. Next, the generation unit 111a arranges a control signal generation circuit or the like to be connected to the generated logic cone on the grid in accordance with a certain rule. In this way, the generation unit 111a generates the first layout that includes the logic cone and the control signal generation circuit including the logic cells each having a basic logic structure. As with the above logic cone, the generation unit 111a generates the control signal generation circuit by first arranging an output-side logic cell and next sequentially connects other logic cells to the output-side logic cell on the grid in accordance with a certain rule until input-side logic cells such as FFs are connected.

Next, the calculation unit 111b calculates an area ratio between two triangles in the logic cone generated by the generation unit 111a: one triangle having a logic cell as an angle located in a certain logic cell stage and two logic cells as the other angles located in the input logic cell stage; and the other triangle being having a logic cell as an angle located in the output logic cell stage and two logic cells as the other angles located in the certain logic cell stage. Next, the calculation unit 111b determines whether the calculated area ratio matches a predetermined ratio, for example, 1:1.

For example, in the logic cone generated by the generation unit 111a, the calculation unit 111b generates a first triangle having a logic cell as an angle located in a certain stage and two logic cells (FFs, etc.) as the other angles located at both ends in the input stage, each of the two logic cells being connected to an input of the logic cell in the certain stage directly or via other logic cells. Next, in the logic cone, the calculation unit 111b generates a second triangle having a logic cell (an FF, etc.) as an angle located in the output stage and two logic cells as the other angles located at both ends in the certain stage (namely, the stage in which one of the angles of the first triangle is located), each of the two logic cells being connected to an input of the logic cell in the output stage directly or via other logic cells. The calculation unit 111b calculates each of the areas of the first and second triangles generated as described above, calculates the ratio between the areas (the area ratio between the first and second triangles), and determines whether the obtained ratio matches a predetermined ratio.

If the calculation unit 111b determines that the area ratio between the first and second triangles formed on the basis of the certain logic cell stage matches the predetermined ratio, the setting unit 111c sets this logic cell stage as a logical division stage. Next, the setting unit 111c sets a first logic cone block formed between the logical division stage and the input logic cell stage and a second logic cone block formed between the output logic cell stage and the logical division stage as logic synthesis units.

For example, if the calculation unit 111b determines that the area ratio calculated on the basis of the certain logic cell stage (the stage in which one of the angles of the first triangle is located) matches the predetermined ratio, the setting unit 111c sets the certain logic cell stage as the logical division stage for dividing the logic. Next, the setting unit 111c sets the first logic cone block, which is obtained by tracing the logic cells from the logical division stage to the input stage (or from the input stage to the logical division stage), as a first logic synthesis unit. The setting unit 111c also sets a second logic cone block, which is obtained by tracing the logic cells from the output stage to a stage next to the logical division stage in the output stage direction (or from this stage to the output stage), as a second logic synthesis unit.

More specifically, in the above processing, first, the setting unit 111c divides the control signal generation circuit in the first layout generated by the generation unit 111a at the logical division stage. Next, the setting unit 111c connects at least one divided portion of the control signal generation circuit to the first logic cone block and the other divided portions to the second logic cone block so that a second layout is generated. The setting unit 111c compares the area of a third triangle with the area of a fourth triangles. The third triangle has a logic cell as an angle located in the output stage and logic cells as the other angles at both ends of the input stage in the first layout that includes the control signal generation circuit before the division. The fourth triangle has a logic cell as an angle located in the output stage and two logic cells as the other angles at both ends of the input stage in the second layout that includes the divided control signal generation circuits. If the area of the fourth triangle is smaller than that of the third triangle, the setting unit 111c sets the first and second logic cone blocks as the first and second logic synthesis units, respectively.

The setting unit 111c adds the first and second logic synthesis units to the synthesis constraints 4.

The logic synthesis processing unit 112 performs logic synthesis processing by using information in the RTL design data 1, the timing library 2, the timing constraints 3, and the synthesis constraints 4 which includes information about the first and second logic synthesis units set by the LSU setting processing unit 111. The logic synthesis processing is performed in accordance with the logic synthesis program 10.

The logic synthesis unit 110 causes the logic synthesis processing unit 112 to perform the logic synthesis by using the synthesis constraints 4 including the information about the first and second logic synthesis units set by the LSU setting processing unit 111 as described above. As a result, the logic synthesis unit 110 generates the gate-level netlist 6.

The wiring arrangement unit 120 performs wiring arrangement by using information in the timing library 2, the timing constraints 3, the layout library 7, the layout constraints 8, and the netlist 6 generated by the logic synthesis unit 110 and generates the wiring arrangement data 9. The wiring arrangement processing is performed in accordance with the wiring arrangement program 11.

Hereinafter, a designing method by using the designing apparatus 100 will be described in detail. The following description will mainly describe a logic synthesis method used in designing by the designing apparatus 100.

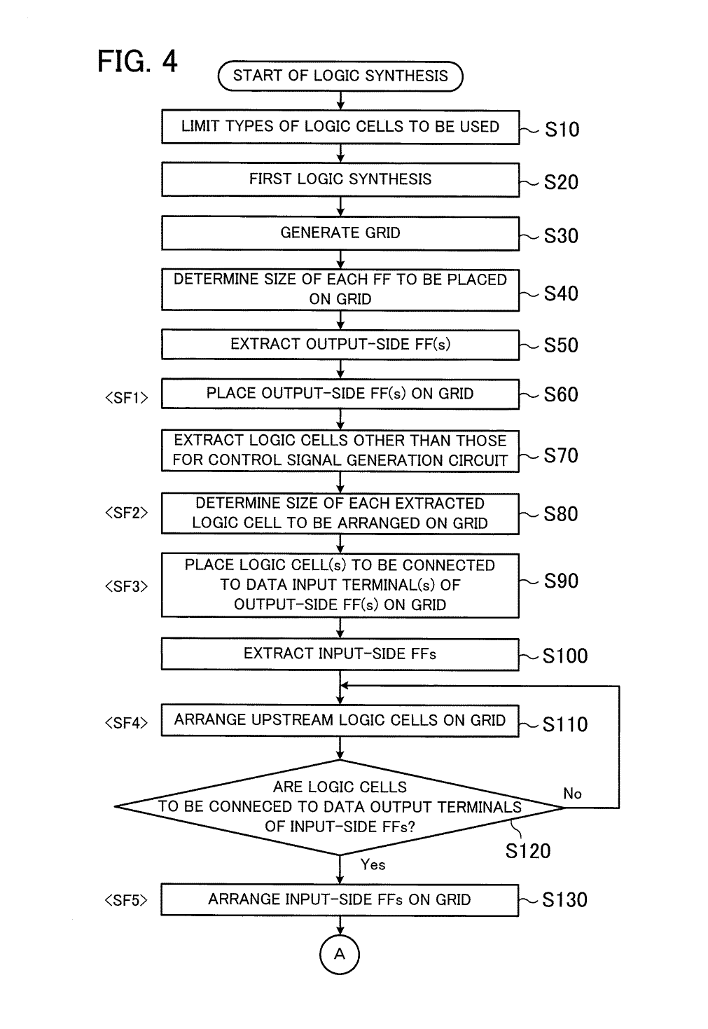

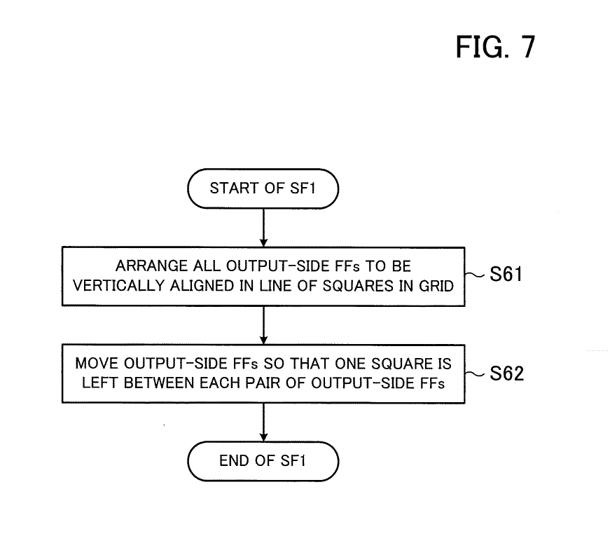

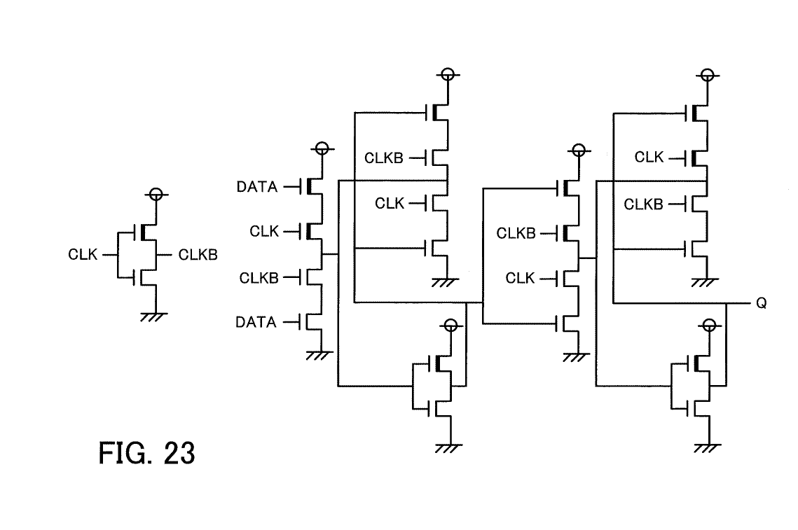

FIGS. 4 to 6 illustrate an exemplary logic synthesis flow. Exemplary predetermined steps performed in the logic synthesis flow illustrated in FIGS. 4 to 6 are illustrated in FIGS. 7 to 22 as subflows (SFs). FIGS. 23 to 36A to 36C are explanatory diagrams illustrating predetermined steps performed in the logic synthesis flow illustrated in FIGS. 4 to 6. Hereinafter, the flow in FIGS. 4 to 6 will sequentially be described with reference to the SFs in FIGS. 7 to 22 and the explanatory diagrams in FIG. 23 to FIGS. 36A to 36C.

In the logic synthesis performed by the logic synthesis unit 110 in the designing apparatus 100, first, the logic cells other than those for the control signal generation circuit are arranged on the grid.

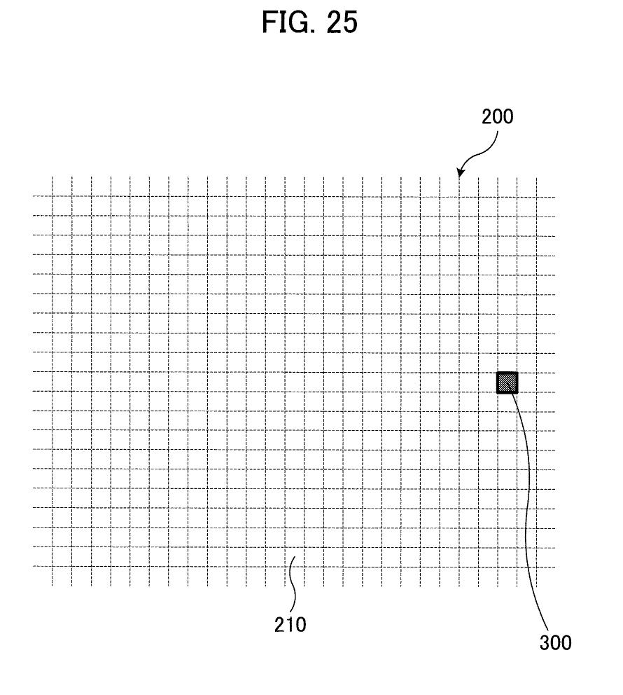

First, the generation unit 111a in the LSU setting processing unit 111 limits types of logic cells to be used to those having basic driving capabilities, such as a NAND/NOR gate, an inverter, a 2-input 1-output selector, an FF, and the like (step S10 in FIG. 4), and performs logic synthesis (first logic synthesis) only on these logic cells (step S20 in FIG. 4). The generation unit 111a generates a grid formed by squares each having the same vertical and horizontal length (for example, a grid 200 illustrated in FIG. 25) (step S30). Next, as will be described below, the generation unit 111a places and arranges logic cells on the generated grid so that the first layout including a predetermined logic cone is generated. Examples of the logic cone include a multi-input multi-output selector circuit and a multi-input 1-output selector circuit.

After generating the grid in step S30, the generation unit 111a determines the size of an FF to be placed on the grid (step S40 in FIG. 4). As illustrated in FIG. 23, the FF has a circuit structure having two inputs of a clock “CLK” and data “DATA” and an output “Q.” The FF stores a logic value (1, 0) of the data “DATA” when the clock “CLK” is input, and the FF maintains the state until the next clock “CLK” is input. For example, the generation unit 111a sets the size of an FF having a circuit configuration as illustrated in FIG. 23 to the size of one square on the grid.

The generation unit 111a extracts an output-side FF by using the result obtained in step S20 (step S50 in FIG. 4) and places the extracted output-side FF on one of the squares on the grid (step S60 in FIG. 4). If a plurality of output-side FFs is extracted in step S50, as described with SF1 in FIG. 7, the generation unit 111a arranges all the extracted output-side FFs to be vertically aligned in a line of squares on the grid (step S61 in FIG. 7) and moves the output-side FFs so that one square is left between each pair of output-side FFs (step S62 in FIG. 7).

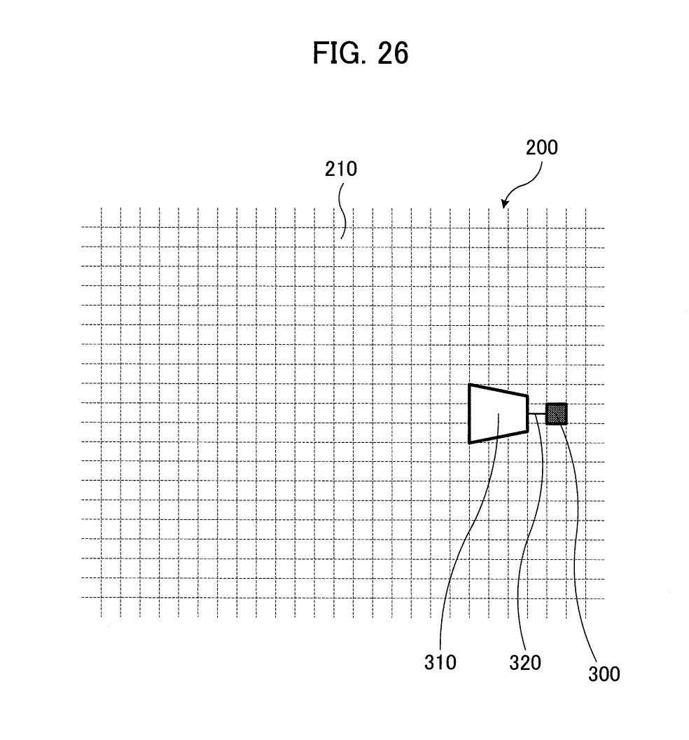

FIG. 25 (also in FIGS. 26 to 33) illustrates exemplary processing for generating a 64-input 1-output selector circuit (a 64-to-1 multiplexer). For example, the 64-input 1-output selector circuit includes 64 input-side FFs, 2-input 1-output selectors arranged in a predetermined number of stages (32, 16, 8, 4, 2, and 1 2-input 1-output selectors are arranged in 6 stages, respectively), and an output-side FF.

An example in which such a 64-input 1-output selector circuit is generated in accordance with steps S10 to S60 will be described. In this example, first, the generation unit 111a limits types of logic cells to be used and performs logic synthesis on these logic cells (steps S10 and S20 in FIG. 4). Next, the generation unit 111a generates the grid 200 as illustrated in FIG. 25 (step S30 in FIG. 4) and determines that each FF to be placed on the grid 200 occupies one square in the grid 200 (step S40 in FIG. 4). The generation unit 111a extracts an output-side FF 300 (in this example, a single output-side FF) by using the result obtained in step S20 (step S50 in FIG. 4). The generation unit 111a places the extracted output-side FF 300 on a square 210 in the grid 200 (for example, on a square 210 on the right side of the grid 200) (step S60 in FIG. 4).

After placing the output-side FF as described above, the generation unit 111a extracts logic cells other than those for the FF and the control signal generation circuit by using the result obtained in step S20 (step S70 in FIG. 4) and determines the size of each of the extracted logic cells on the grid (step S80 in FIG. 4).

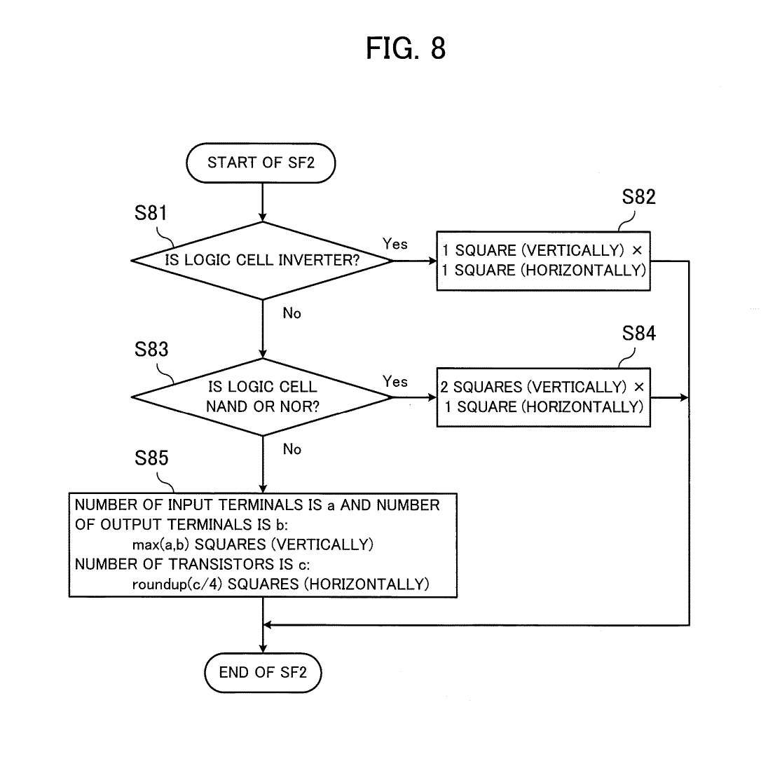

For example, as illustrated in SF2 in FIG. 8, if an extracted logic cell is an inverter (step S81 in FIG. 8), the generation unit 111a sets the size of the logic cell to 1 square in a vertical direction and 1 square in a horizontal direction on the grid (step S82 in FIG. 8).

If an extracted logic cell is a NAND or NOR gate (step S83 in FIG. 8), the generation unit 111a sets the size of the logic cell to 2 squares in a vertical direction and 1 square in a horizontal direction on the grid (step S84 in FIG. 8).

If an extracted logic cell is not an inverter or a NAND or NOR gate, the generation unit 111a acquires information about the number of input terminals, the number of output terminals, and the number of transistors from the cell netlist 5 and determines the size on the basis of the information (step S85 in FIG. 8). When the number of input terminals is “a” and the number of output terminals is “b”, the generation unit 111a sets the vertical size of the logic cell to the number of squares corresponding to the larger number of the two values “a” and “b.” When the number of transistors is “c”, the generation unit 111a sets the horizontal size of the logic cell to the number of squares, the number obtained by dividing the value c by 4 and rounding up the remainder.

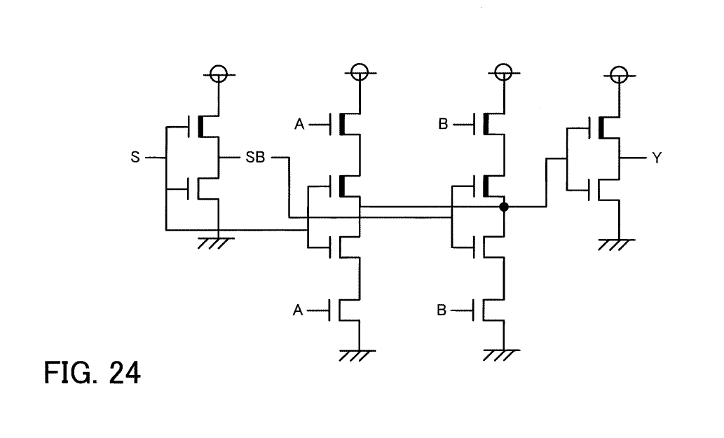

For example, FIG. 24 illustrates a 2-input 1-output selector which has a circuit structure including two inputs A and B and one output Y. The selector outputs either the input A or B as the output Y in accordance with a selection signal S. If an extracted logic cell is such a 2-input 1-output selector as illustrated in FIG. 24, since the number “a” of input terminals is 3, the number “b” of output terminals is 1, and the number “c” of transistors is 12, the generation unit 111a sets the size of the logic cell to 3 squares (vertically)×3 squares (horizontally).

After extracting predetermined logic cells and determining the size of each of the extracted logic cells in steps S70 and S80, the generation unit 111a places a logic cell (a logic cell upstream of the output-side FF) to be connected to a data input terminal of the output-side FF on the grid (step S90 in FIG. 4). In this embodiment, an upstream stage of a logic cell means a stage located on the input side of the logic cell and a downstream stage of a logic cell means a stage located on the output side of the logic cell.

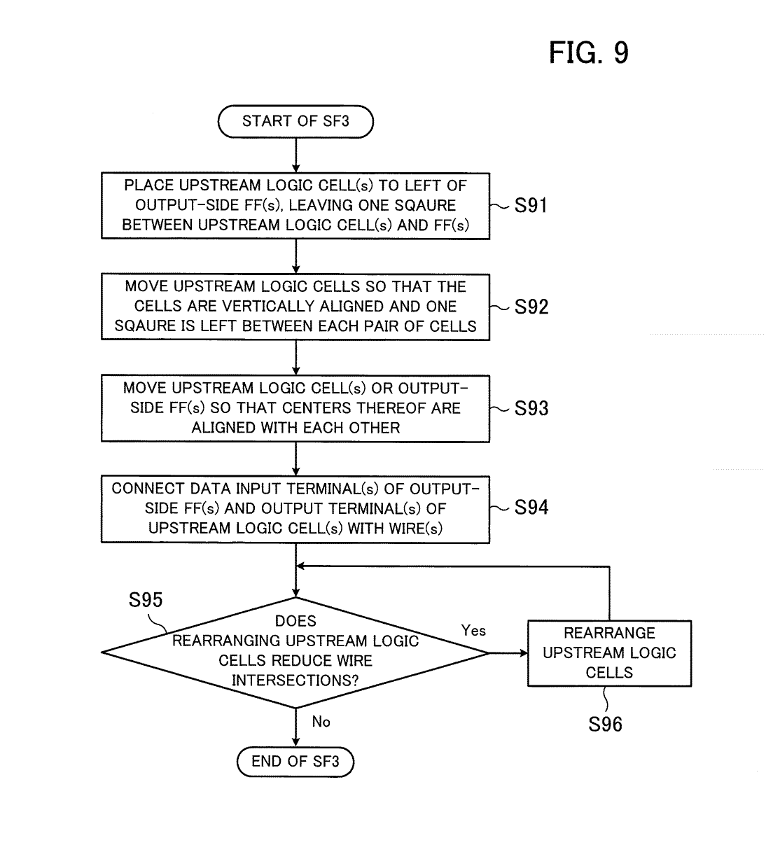

In step S90, as illustrated in SF3 in FIG. 9, the generation unit 111a places an upstream logic cell(s) to the left of the output-side FF(s), leaving one square therebetween (step S91 in FIG. 9).

If a plurality of logic cells is placed upstream of the output-side FF(s), the generation unit 111a moves the upstream logic cells so that the upstream logic cells are vertically aligned on the grid and one square is left between each pair of upstream logic cells (step S92 in FIG. 9). In step S92, the generation unit 111a may vertically arrange the plurality of upstream logic cells on the grid in an arbitrary order.

After placing and moving the upstream logic cell(s), the generation unit 111a moves the upstream logic cell(s) (or the output-side FF(s)) so that the center of the output-side FF(s) and the center of the upstream logic cell(s) are aligned with each other (step S93 in FIG. 9).

Next, the generation unit 111a connects the data input terminals of the output-side FF(s) and the output terminal(s) of the upstream logic cell(s) with wires (step S94 in FIG. 9).

Next, the generation unit 111a determines whether rearranging relevant upstream logic cell(s) reduces wire intersections (step S95 in FIG. 9). If a plurality of logic cells is arranged upstream of the output-side FF(s) and if rearranging relevant upstream logic cells reduces wire intersections, the generation unit 111a rearranges the relevant upstream logic cells (step S96 in FIG. 9). Next, the processing returns to step S95. If a single logic cell is placed upstream of the output-side FF(s), the processing proceeds to step S100. Even when the generation unit 111a arranges a plurality of upstream logic cells, if rearranging any of the upstream logic cells does not reduce wire intersections, the processing proceeds to step S100.

Such processing performed in steps S95 and S96 allows the generation unit 111a to arrange the upstream logic cell(s) connected to the output-side FF(s) near the output-side FF(s) without increasing the wire lengths and causing unnecessary wire intersections. In addition, this processing performed in steps S95 and S96 allows the generation unit 111a to arrange the upstream logic cells in an arbitrary order in step S91.

Steps S70 to S90 will be described by using the 64-input 1-output selector circuit as an example. In this example, first, the generation unit 111a extracts a 2-input 1-output selector as a logic cell by using the result obtained in step S20 (step S70 in FIG. 4).

The generation unit 111a determines the size occupied by the extracted 2-input 1-output selector on the grid 200 illustrated in FIG. 26 (step S80 in FIG. 4) and places the 2-input 1-output selector on the grid 200 (step S90 in FIG. 4).

In step S90, as illustrated in FIG. 26, the generation unit 111a places a single upstream 2-input 1-output selector (hereinafter, simply referred to as a “selector”) 310 (an upstream logic cell) to the left of the single output-side FF 300 on the grid 200, leaving one square between the selector 310 and the FF 300 (step S91 in FIG. 9). The selector 310 placed upstream of the output-side FF 300 has a size of 3 (vertical)×3 (horizontal) squares 210 on the grid 200 (steps S81 to S85 in FIG. 8).

The generation unit 111a moves the output-side FF 300 or the selector 310 so that the center of the output-side FF 300 and the center of the selector 310 are aligned with each other (step S93 in FIG. 9).

Next, the generation unit 111a connects the data input terminal of the output-side FF 300 and the output terminal of the selector 310 with a wire 320 (step S94 in FIG. 9).

In this example, since the 64-input 1-output selector circuit has a configuration in which the single upstream selector 310 is connected upstream of the single output-side FF 300, reduction of wire intersections by rearranging the logic cell does not occur. Thus, the processing proceeds to step S100.

After placing the logic cell(s) upstream of the output-side FF(s) on the grid as described in step S90, the generation unit 111a extracts input-side FFs by using the result obtained in step S20 (step S100 in FIG. 4) and places the logic cell(s) in a further upstream stage on the grid (step S110 in FIG. 4).

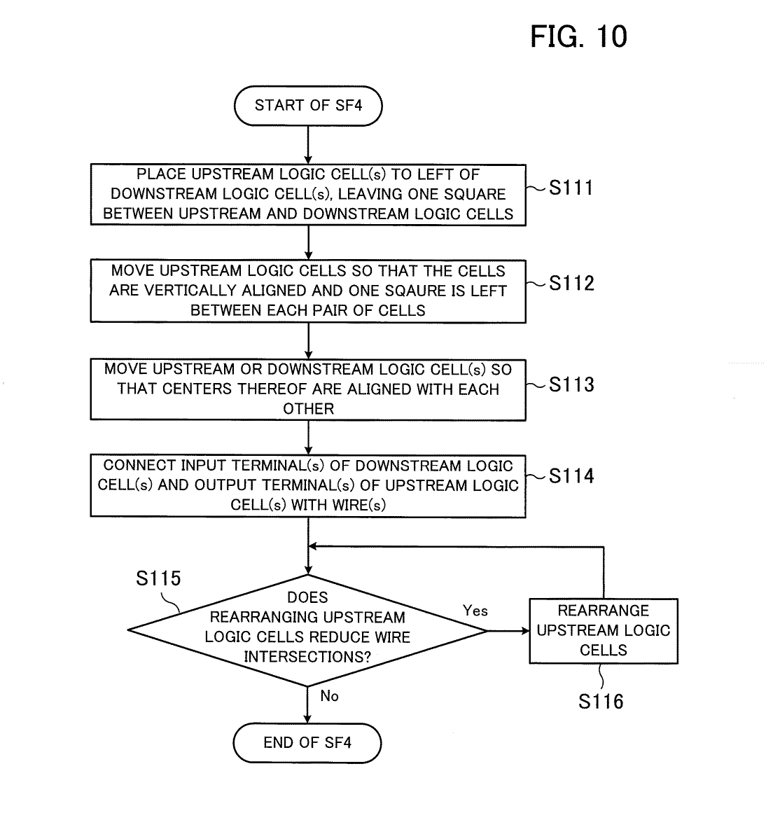

In step S110, the generation unit 111a performs processing illustrated in SF4 in FIG. 10 for placing a logic cell(s) in a stage(s) further upstream of the logic cell(s) located upstream of the output-side FF(s).

First, the generation unit 111a places a logic cell(s) upstream of the placed logic cell(s), which is to be a downstream logic cell(s), to the left of the downstream logic cell(s), leaving one square between the upstream and downstream logic cells (step Sill in FIG. 10).

If a plurality of upstream logic cells is arranged, the generation unit 111a moves the upstream logic cells so that the upstream logic cells are vertically aligned on the grid and one square is left between each pair of upstream logic cells (step S112 in FIG. 10). In step S112, the generation unit 111a may vertically arrange the plurality of upstream logic cells on the grid in an arbitrary order.

After the upstream logic cell(s) is placed and moved, the generation unit 111a moves the upstream logic cell(s) so that the centers of the upstream and downstream logic cells are aligned with each other (step S113 in FIG. 10).

Next, the generation unit 111a connects an input terminal(s) of the downstream logic cell(s) and the output terminal(s) of the upstream logic cell(s) with a wire(s) (step S114 in FIG. 10).

Next, the generation unit 111a determines whether rearranging any of the upstream logic cells reduces any wire intersections (step S115 in FIG. 10). If a plurality of upstream logic cells is arranged and if rearranging relevant upstream logic cells reduces wire intersections, the generation unit 111a rearranges the relevant upstream logic cells (step S116 in FIG. 10). Next, the processing returns to step S115. If the generation unit 111a places a single upstream logic cell, the processing proceeds to step S120. Even when the generation unit 111a arranges a plurality of upstream logic cells, if rearranging any of the upstream logic cells does not reduce any wire intersections, the processing proceeds to step S120.

Such processing performed in steps S115 and S116 allows the generation unit 111a to place an upstream logic cell(s) connected to the downstream logic cell(s) near the downstream logic cell(s) without increasing the wire lengths and causing unnecessary wire intersections. In addition, this processing performed in steps S115 and S116 allows the generation unit 111a to arrange the upstream logic cells in an arbitrary order in step S111.

The generation unit 111a repeats such arrangement of upstream logic cells until logic cells to be connected to input-side FFs are arranged (step S120 in FIG. 4).

Steps S100 to S120 will be described by using the 64-input 1-output selector circuit as an example. In this example, the generation unit 111a extracts input-side FFs by using the result obtained in step S20 (step S100 in FIG. 4) and arranges 2-input 1-output selectors on the grid as upstream logic cells (step S110 in FIG. 4).

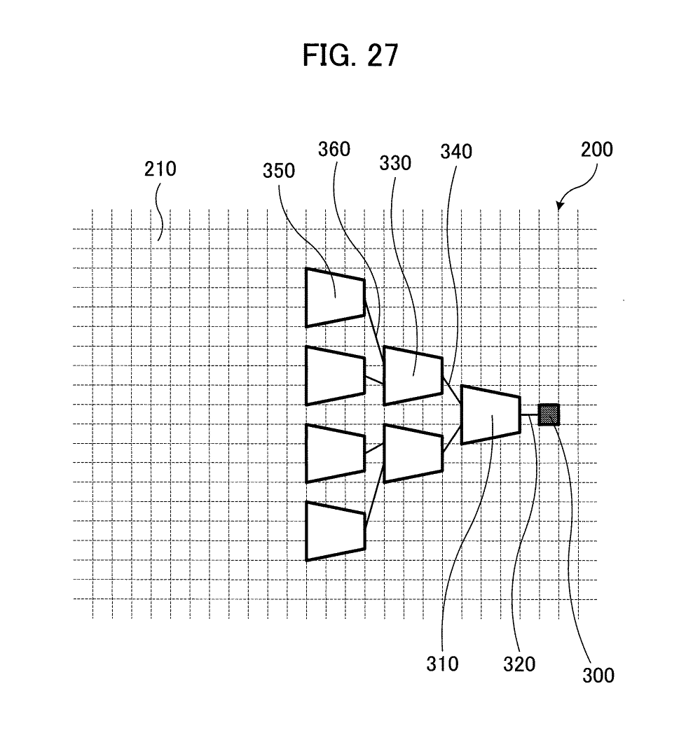

In step S110, as illustrated in FIG. 27, the generation unit 111a arranges two 2-input 1-output selectors (hereinafter, simply referred to as “selectors”) 330 (upstream logic cells) upstream of the single selector 310 (downstream logic cell) to the left of the downstream selector 310 on the grid 200, leaving one square between the selectors 330 and the selector 310 (step S111 in FIG. 10). Each of the selectors 330 has a size of 3 (vertical)×3 (horizontal) squares 210 on the grid 200.

The generation unit 111a moves the two selectors 330 so that the two selectors 330 are vertically aligned and one square is left between the selectors 330 (step S112 in FIG. 10).

The generation unit 111a moves the two selectors 330 so that the centers of the single selector 310 and the two selectors 330 are aligned with each other (step S113 in FIG. 10).

The generation unit 111a connects the input terminals of the selector 310 and the output terminals of the two selectors 330 with wires 340 (step S114 in FIG. 10).

In this example, since the 64-input 1-output selector circuit has a configuration in which the two upstream selectors 330 are connected upstream of the single selector 310, reduction of wire intersections by rearranging the logic cells does not occur. Next, the processing proceeds to step S120.

In the 64-input 1-output selector circuit, the selectors 330 are not connected to the input-side FFs (step S120 in FIG. 4). Therefore, the generation unit 111a arranges four 2-input 1-output selectors (hereinafter, simply referred to as “selectors”) 350 (upstream logic cells) further upstream of the two selectors 330 (downstream logic cells) to the left of the downstream selectors 330 on the grid 200, leaving one square between the selectors 330 and the selectors 350 (step S111 in FIG. 10). Each of the selectors 350 has a size of 3 (vertical)×3 (horizontal) squares 210 on the grid 200.

The generation unit 111a moves the four selectors 350 so that the four selectors 350 are vertically aligned and one square is left between each pair of selectors 350 (step S112 in FIG. 10).

The generation unit 111a moves the four selectors 350 so that the center of the two selectors 330 is aligned with the center of the four selectors 350 (step S113 in FIG. 10).

The generation unit 111a connects the input terminals of the two selectors 330 and the output terminals of the four selectors 350 with wires 360 (step S114 in FIG. 10).

If rearranging relevant selectors 350 reduces intersections of the wires 360 (step S115 in FIG. 10), the generation unit 111a rearranges the relevant selectors 350 (step S116 in FIG. 10). FIG. 27 illustrates a state in which rearranging the selectors 350 does not reduce or has already reduced intersections of the wires 360.

The generation unit 111a repeats such processing until the 2-input 1-output selectors to be connected to the input-side FFs have been arranged (step S120 in FIG. 4).

The generation unit 111a sequentially arranges and connects other logic cells from the output-side FF toward the input-side direction. When the logic cells to be connected to the data output terminals of the input-side FFs are arranged (step S120 in FIG. 4), the generation unit 111a arranges the input-side FFs on the grid (step S130 in FIG. 4).

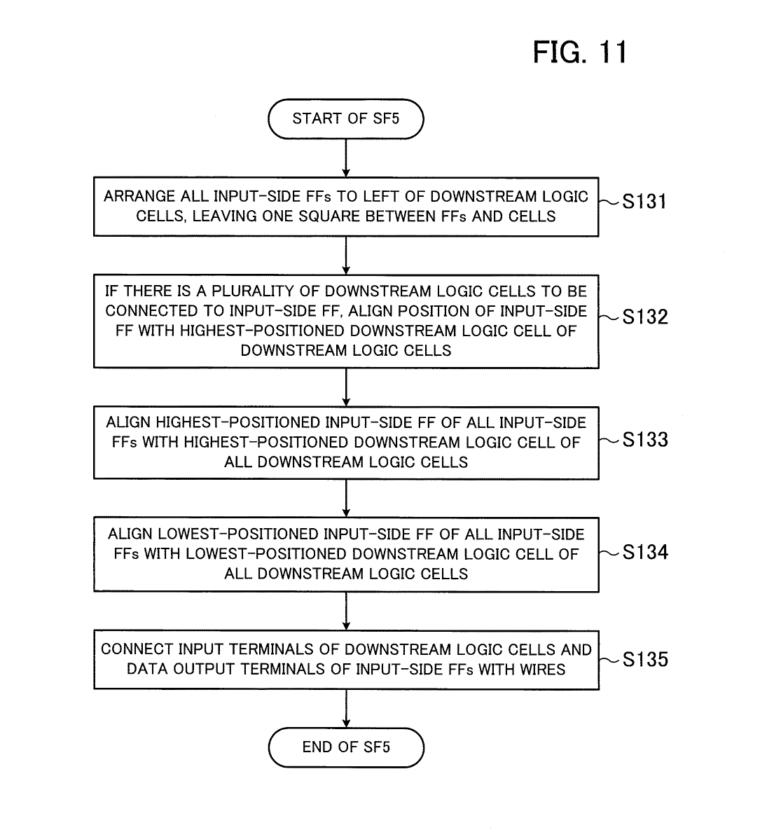

In step S130, as illustrated in SF 5 in FIG. 11, the generation 111a arranges all the input-side FFs to the left of the respective downstream logic cells, leaving one square between the FFs and the cells (step S131 in FIG. 11).

If there is a plurality of downstream logic cells to be connected to a single input-side FF, the generation 111a places the input-side FF by aligning the position of the input-side FF with the highest-positioned logic cell of the plurality of downstream logic cells on the grid (step S132 in FIG. 11).

The generation unit 111a aligns the highest-positioned input-side FF of all the input-side FFs on the grid with the highest-positioned logic cell of all the downstream logic cells on the grid (step S133 in FIG. 11).

Next, the generation unit 111a aligns the lowest-positioned input-side FF of all the input-side FFs on the grid with the lowest-positioned logic cell of all the downstream logic cells on the grid (step S134 in the FIG. 11).

The generation unit 111a connects the input terminals of the downstream logic cells and the data output terminals of the input-side FFs with wires (step S135 in FIG. 11).

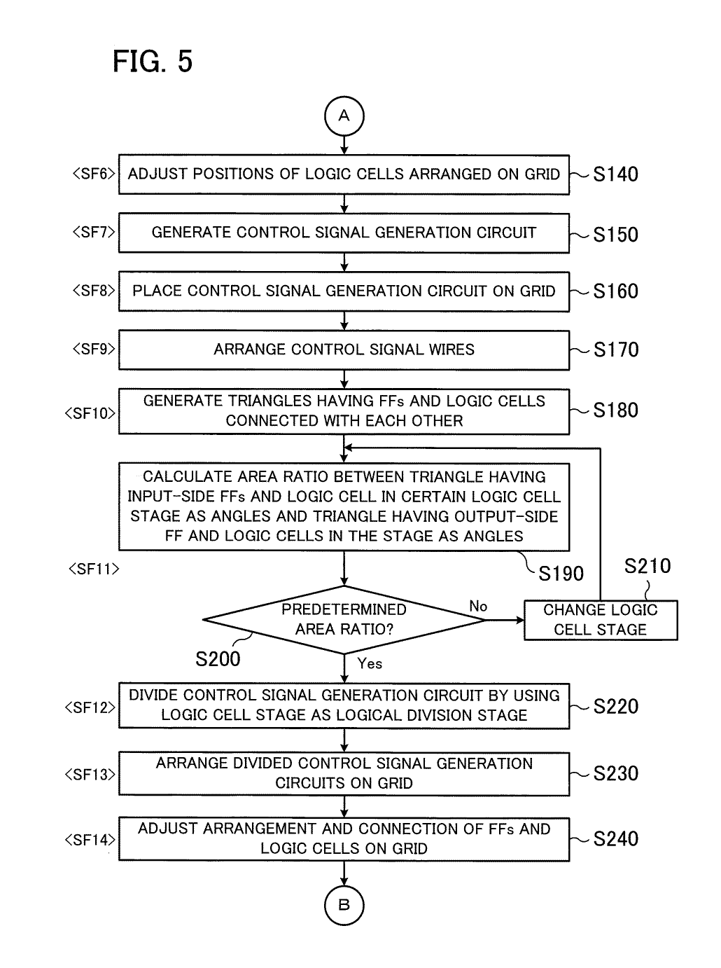

After arranging the input-side FFs as described above, the generation unit 111a performs processing for adjusting the positions of the logic cells that have been arranged on the grid in the previous steps (step S140 in FIG. 5).

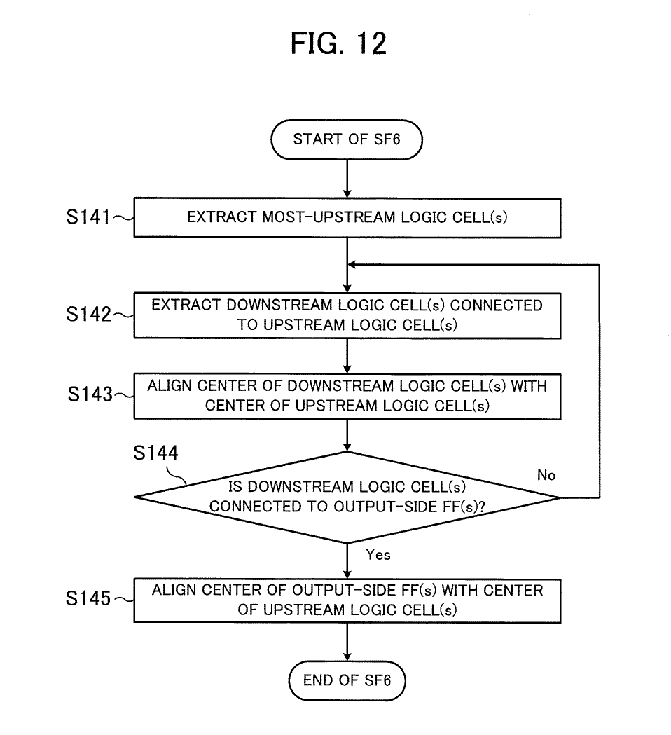

In step S140, as illustrated in SF6 in FIG. 12, the generation unit 111a extracts the input-side FFs and a logic cell(s) connected to the input-side FFs (the most-upstream logic cell(s)) on the grid (step S141 in FIG. 12).

The generation unit 111a extracts a downstream logic cell(s) connected to the most-upstream logic cell(s) (step S142 in FIG. 12).

The generating unit 111a aligns the center of the extracted downstream logic cell(s) with the center of upstream logic cell(s) connected to the extracted downstream logic cell(s) on the grid (step S143 in FIG. 12).

The generation unit 111a determines whether the downstream logic cell(s) is connected to the output-side FF(s) (step S144 in FIG. 12) and repeats the processing in steps S142 and S143 until the generation unit 111a determines that the extracted logic cell(s) is connected to the output-side FF(s).

If the generation unit 111a determines that the downstream logic cell(s) is connected to the output-side FF(s), the generation unit 111a aligns the center of the output-side FF(s) with the center of the downstream logic cell(s) (the upstream logic cell(s) if the downstream logic cell(s) is seen from the output-side FF(s)) (step S145 in FIG. 12).

Steps S120 to S140 will be described by using the 64-input 1-output selector circuit as an example. In this example, first, the generation unit 111a determines whether the placed logic cell, namely, the placed 2-input 1-output selector, is to be connected to an input-side FF (step S120 in FIG. 4).

If the placed 2-input 1-output selector is to be connected to an input-side FF, the generation unit 111a places the input-side FF on the grid (step S130 in the FIG. 4). Next, the generation unit 111a adjusts the positions of the input-side FFs, the 2-input 1-output selectors, and the output-side FF placed on the grid (step S140 in FIG. 5).

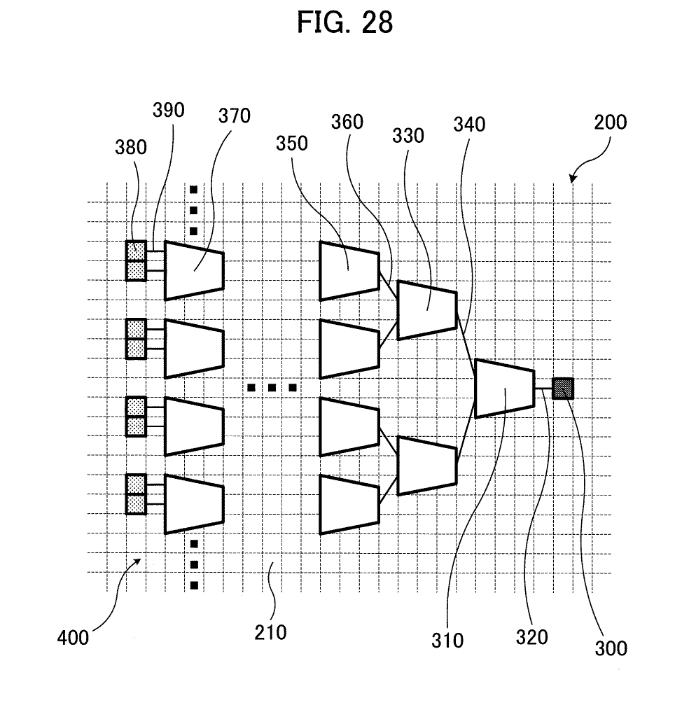

As illustrated in FIG. 28, the generation unit 111a arranges input-side FFs 380 to the left of 2-input 1-output selectors (hereinafter, simply referred to as “selectors”) 370, which are to be connected to the input-side FFs 380, on the grid 200, leaving one square between the FFs 380 and the selectors 370 (steps S120 and S130 in FIG. 4). Each of the selectors 370 has a size of 3 (vertical)×3 (horizontal) squares 210 on the grid 200. Each of the input-side FFs has a size of 1 square 210 on the grid 200. Two input-side FFs 380 are connected to each of the selectors 370.

The generation unit 111a arranges two input-side FFs 380 to the left of each of the selectors 370, leaving one square between the FFs 380 and the selector 370 (steps S131, S132 in FIG. 11).

The generation 111a aligns the highest-positioned input-side FF 380 of all the input-side FFs 380 on the grid 200 with the highest-positioned selector 370 of all the selectors 370 on the grid 200 (step S133 in FIG. 11).

The generation unit 111a aligns the lowest-positioned input-side FF 380 of all the input-side FFs 380 on the grid 200 with respect to the lowest-positioned selector 370 of all the selectors 370 on the grid 200 (step S134 in the FIG. 11).

The generation unit 111a connects the input terminals of the selectors 370 and the data output terminals of the input-side FFs 380 with wires 390 (step S135 in FIG. 11).

Next, the generation unit 111a extracts the input-side FFs 380 and the selectors 370 (step S141 in FIG. 12), extracts selectors connected to the selectors 370 (step S142 in FIG. 12), and aligns the center of the selectors 370 with the center of the extracted selectors (step S143 in FIG. 12). The generation unit 111a performs such processing on the rest of the selectors and the output-side FF 300 (steps S144 and S145 in FIG. 12).

By performing processing in steps S10 to S140 (including SF1 to SF6) as described above, a logic cone (for example, a logic cone 400 in FIG. 28), which is a circuit network formed by the predetermined logic cells, is generated and arranged on the grid. Information about this logic cone is stored in a storage unit (a memory or the like) in the designing apparatus 100, for example.

After adjusting the positions of the logic cells arranged on the grid as described above, the generation unit 111a generates a control signal generation circuit (step S150 in FIG. 5), places the generated control signal generation circuit at a predetermined location on the grid (step S160 in FIG. 5), and arranges control signal wires (step S170 in FIG. 5).

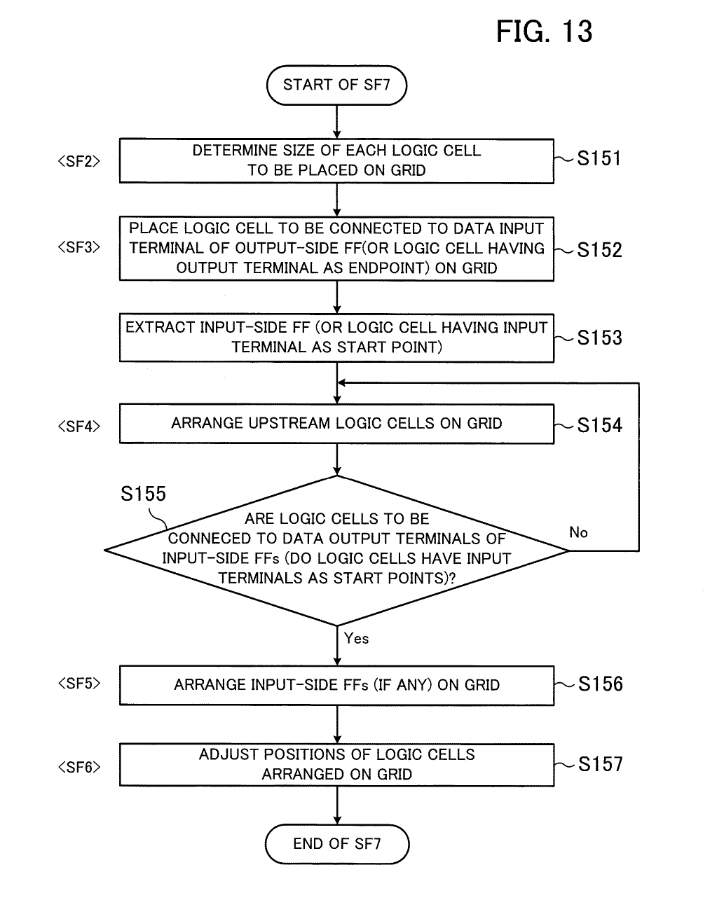

In step S150, as illustrated in SF7 in FIG. 13, the generation unit 111a performs processing in accordance with steps S80 to S140 (SF2 to SF6) and generates a control signal generation circuit. In step S150, if the control signal generation circuit does not include any input-side FF or output-side FF, the generation unit 111a performs processing by using an output terminal or an input terminal of a logic cell as an FF. In such case, the horizontal width (the number of squares) of the output terminal and input terminal of a logic cell used as an FF on the gird is set to 0.

First, in accordance with SF2 in FIG. 8, the generation unit 111a determines the size of a logic cell to be placed on the grid (step S151 in FIG. 13).

Next, in accordance with SF3 in FIG. 9, the generation unit 111a places a logic cell(s) to be connected to a data input terminal(s) of an output-side FF(s) (or a logic cell(s) having an output terminal(s) serving as an end point) on the grid (step S152 in FIG. 13).

After extracting input-side FFs (or logic cells each having an input terminal(s) serving as a starting point) (step S153 in FIG. 13), in accordance with SF4 in FIG. 10, the generation unit 111a places a logic cell(s) upstream of the logic cell(s) that has been placed on the grid (step S154 in FIG. 13).

The generation unit 111a sequentially places a logic cell(s) in the same way until a logic cell to be connected to a data output terminal(s) of an input-side FF(s) (or a logic cell having an input terminal(s) serving as a starting point) is placed (steps S154 and S155 in FIG. 13).

If input-side FFs are used, in accordance with SF5 in FIG. 11, the generation unit 111a arranges the input-side FFs on the grid (step S156 in FIG. 13).

In accordance with SF6 in FIG. 12, the generation unit 111a adjusts the positions of the logic cells arranged on the grid (step S157 in FIG. 13).

After generating the control signal generation circuit as described above, the generation unit 111a places the generated control signal generation circuit at a predetermined location on the grid (step S160 in FIG. 5).

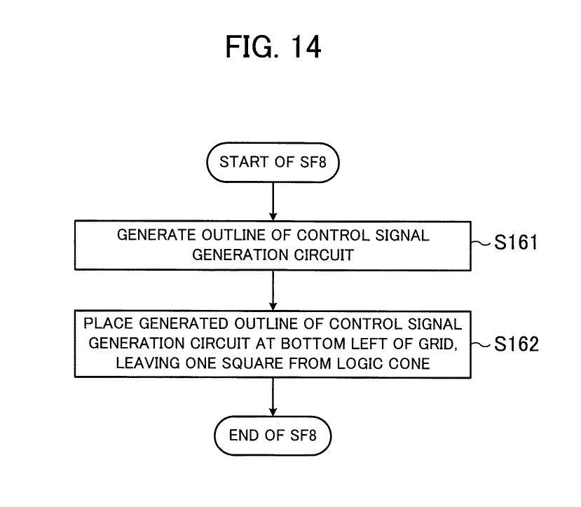

In step S160, as illustrated in SF8 in FIG. 14, the generation unit 111a generates the outline of the generated control signal generation circuit (step S161 in FIG. 14).

The generation unit 111a places the generated outline at the bottom left of the grid, leaving one square from the logic cone (circuit network) arranged on the grid as a result of the processing performed in steps S10 to S140 (including SF1 to SF6) (step S162 in FIG. 14).

After placing the outline of the control signal generation circuit, the generation unit 111a arranges control signal wires that connect the control signal generation circuit and the logic cone (step S170 in FIG. 5).

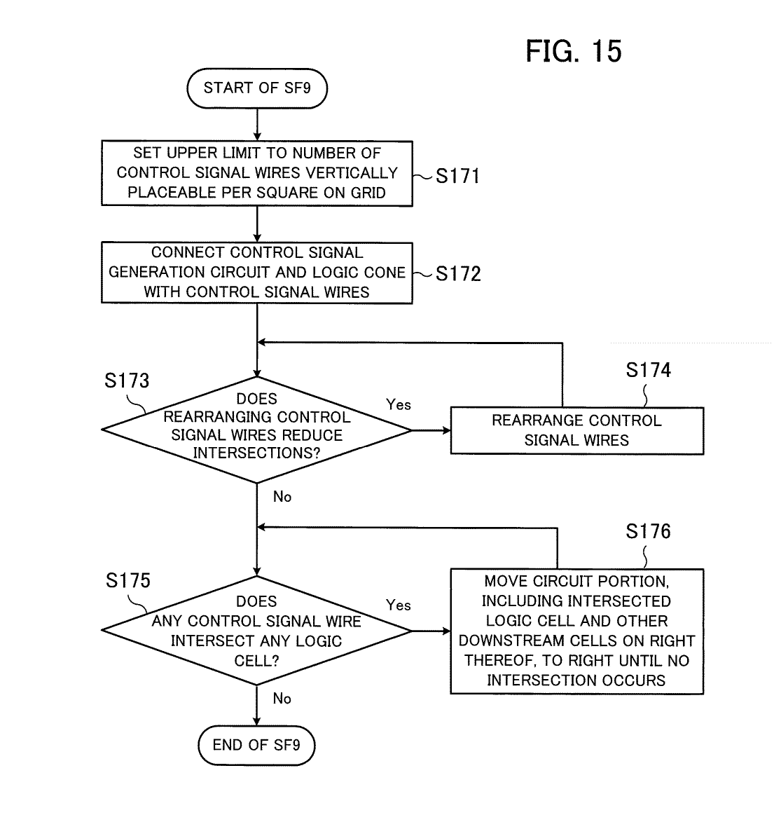

In step S170, as illustrated in SF9 in FIG. 15, first, the generation unit 111a sets an upper limit to the number of control signal wires vertically placeable per square on the grid, for example, on the basis of information about semiconductor technology (formable wire widths, spacing between wires, etc.) and a design-target wiring layer structure (the number of layers used, etc.) (step S171 in FIG. 15). Such information about the semiconductor technology and the wiring layer structure may previously be registered in the synthesis constraints 4.

The generation unit 111a connects the control signal generation circuit and the logic cone on the grid with control signal wires within the number limit set as described above (step S172 in FIG. 15).

If intersections of control signal wires occur by connecting the control signal generation circuit and the logic cone and if rearranging relevant control signal wires reduces the wire intersections (step S173 in FIG. 15), the generation unit 111a rearranges the relevant control signal wires (step S174 in FIG. 15).

If any of the control signal wires intersects any of the logic cells by placing the control signal wires on the grid within the set number limit (step S175 in FIG. 15), the generation unit 111a moves the circuit portion, including the intersected logic cell and the other downstream logic cells on the right thereof, to the right until no control signal wires intersect any logic cells (step S176 in FIG. 15).

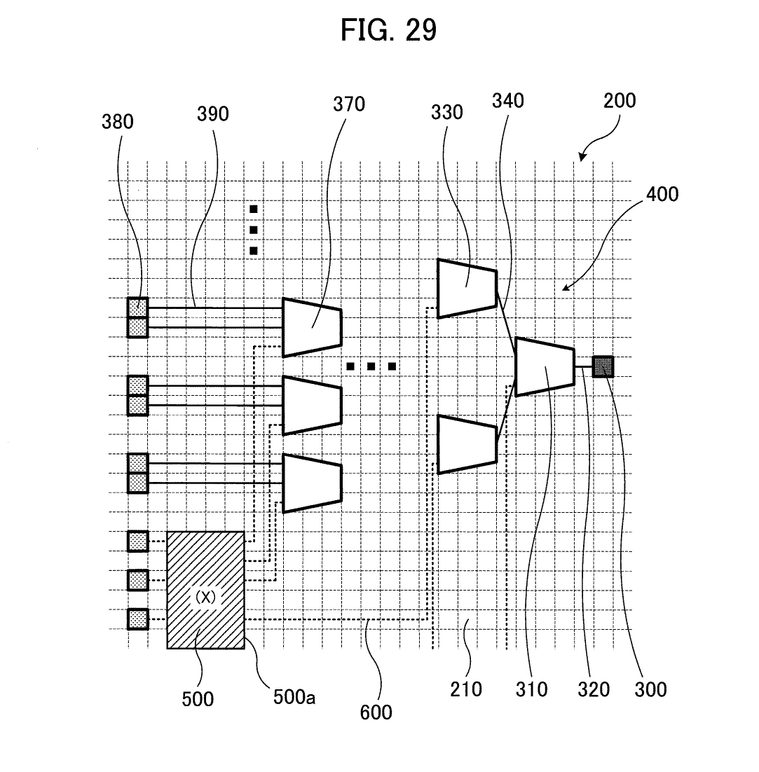

Steps S150 to S170 will be described by using the 64-input 1-output selector circuit as an example. In accordance with step S150 (in FIG. 5) and SF7 (in FIG. 13), the generation unit 111a generates a control signal generation circuit 500 illustrated in FIG. 29 (the internal circuit is not illustrated). For example, the generation unit 111a generates an X-bit decoder (X is a natural number) as the control signal generation circuit 500.

As illustrated in FIG. 29, the generation unit 111a places an outline 500a of the generated control signal generation circuit 500 at the bottom left of the grid 200 (steps S161 and S162 in FIG. 14).

After placing the outline 500a, the generation unit 111a sets an upper limit to the number of control signal wires vertically placeable per square on the grid 200 to two, for example (step S171 in FIG. 15).

The generation unit 111a connects the control signal generation circuit 500 and the logic cone 400 on the grid 200 with control signal wires 600 within the limit set to the number of wires (step S172 in FIG. 15).

If rearranging any of the control signal wires 600 reduces any intersection, the generation unit 111a rearranges relevant control signal wires 600 (steps S173 and S174 in FIG. 15).

If any of the control signal wires 600 intersects any of the 2-input 1-output selectors (logic cells) in the logic cone 400, the generation unit 111a moves the circuit portion, including the intersected 2-input 1-output selectors and the other downstream selectors (up to the output-side FF 300), to the right until no control signal wires intersect any logic cells (steps S175 and 176 in FIG. 15).

By performing the above steps S10 to S170, the first layout that includes the logic cone formed by the predetermined logic cells and the control signal generation circuit (for example, a first layout 21 that includes the logic cone 400 and the control signal generation circuit 500 in FIG. 29) is generated and arranged on the grid. Information about the first layout is stored in the storage unit (a memory or the like) in the designing apparatus 100, for example.

After arranging the logic cone, the control signal generation circuit, and the control signal wires as described above, the calculation unit 111b in the LSU setting processing unit 111 (in FIG. 3) generates triangles each of which is formed by predetermined logic cells as angles (step S180 in FIG. 5). Next, the calculation unit 111b calculates an area ratio between certain triangles (steps S190 to S210 in FIG. 5).

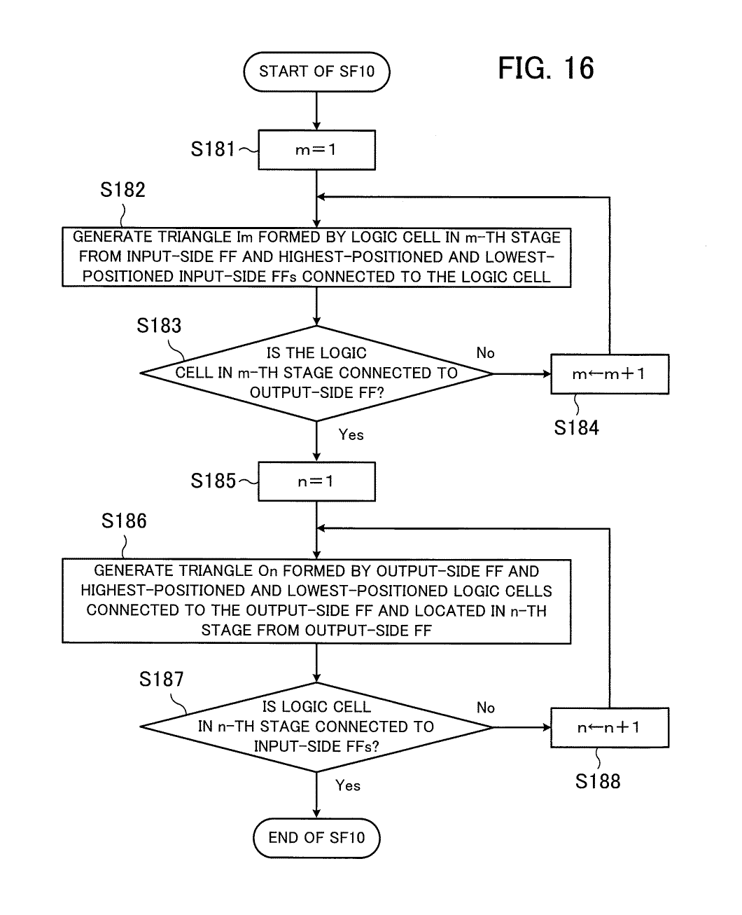

In step S180, as illustrated in SF10 in FIG. 16, first, the calculation unit 111b generates a triangle Im in the logic cone on the grid. The triangle Im has a logic cell as an angle located in an m-th stage from the input-side FFs and the highest-positioned input-side FF and the lowest-positioned input-side FF as the other angles, each of the input-side FFs being connected to the logic cell in the m-th stage. The value m is a natural number that satisfies 1≦m≦X. The value X represents the number of logic cell stages between the input-side FFs and the output-side FF(s). The calculation unit 111b generates triangles I1 to IX. The triangle I1 has a logic cell located in the first stage from the input-side FFs, the logic cell serving as one of the angles of the triangle I1. The triangle IX includes a logic cell connected to the output-side FF (a logic cell upstream of the output-side FF), the logic cell serving as one of the angles of the triangle IX (steps S181 to S184 in FIG. 16).

As illustrated in SF10 in FIG. 16, the calculation unit 111b also generates a triangle On in the logic cone on the grid. The triangle On has the output-side FF and the highest-positioned logic cell and the lowest-positioned logic cell, each of the logic cells being located in an n-th stage from the output-side FF and connected to the output-side FF. The value n is a natural number that satisfies 1≦n≦X. The value X represents the number of logic cell stages between the input-side FFs and the output-side FF. The calculation unit 111b generates triangles O1 to OX. The triangle O1 has logic cells located in the first stage from the output-side FF in a side of the triangle O1. The triangle OX has logic cells each connected to corresponding input-side FFs (logic cells downstream of the input-side FFs) in a side of the triangle OX (steps S185 to S188 in FIG. 16).

After generating the triangles Im and On, the calculation unit 111b performs the following processing.

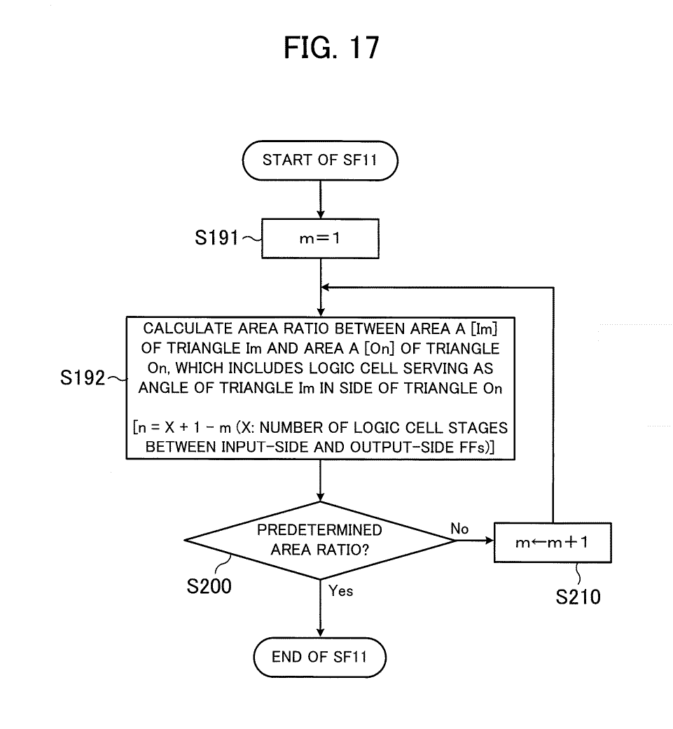

Namely, as illustrated in SF11 in FIG. 17, the calculation unit 111b calculates an area A [Im] of the triangle Im and an area A [On] of the triangle On. The area A [On] is an area of the triangle On (n=X+1−m) in which a logic cell serving as an angle of the triangle Im (namely, a logic cell located in the m-th stage from the input-side FF) is included in a side of the triangle On. Next, the calculation unit 111b calculates an area ratio between the obtained areas A [Im] and [On] (step S192 in FIG. 17).

The calculation unit 111b changes the value m of the m-th logic cell stage and repeats the above processing, so as to obtain a combination of the triangles Im and On whose area ratio matches a predetermined ratio (steps S191, S192, S200, and S210 in FIG. 17).

For example, the calculation unit 111b obtains a combination of the triangles Im and On whose area ratio matches 1:1. The predetermined area ratio between the area A [Im] and the area A [On] may previously be set in the designing apparatus 100. However, the area ratio is not limited to 1:1. An appropriate area ratio may be set on the basis of a type of the semiconductor integrated circuit being designed. Alternatively, the area ratio may be set within a certain range.

The calculation unit 111b provides the setting unit 111c with the obtained information about the combination of the triangles Im and On whose area ratio matches the predetermined area ratio and information about the logic cell stage (the values of m and n) serving as the border between the triangles Im and On whose area ratio matches the predetermined area ratio.

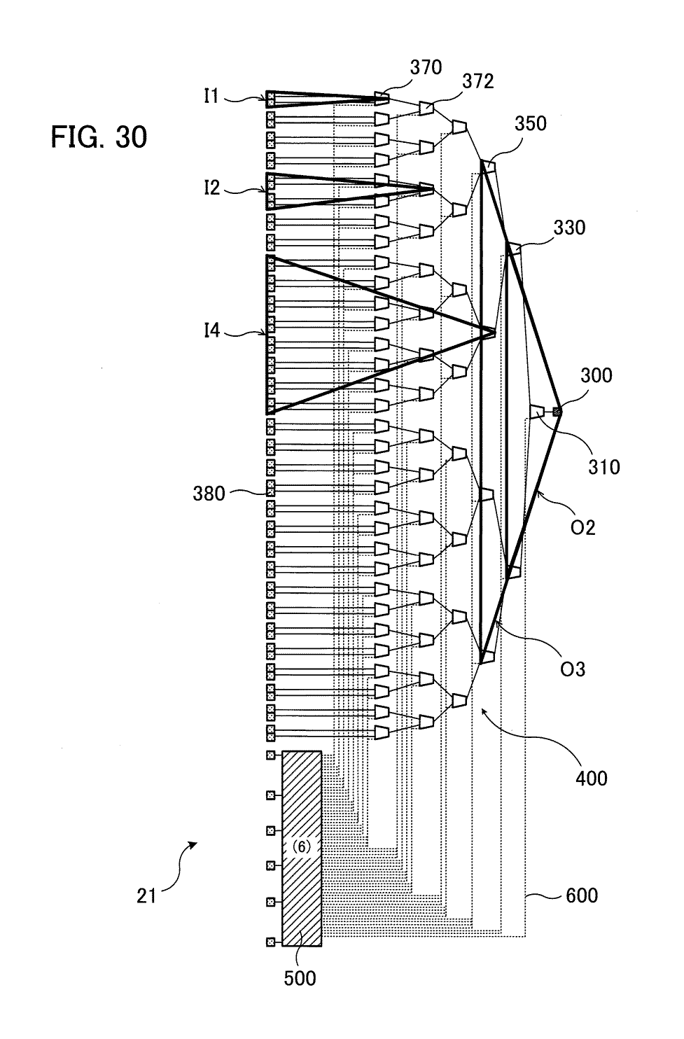

The above triangles Im and On will be described by using the 64-input 1-output selector circuit as an example, with reference to FIG. 30.

FIG. 30 illustrates the first layout 21 obtained by performing steps S10 to S170. Namely, FIG. 30 illustrates the logic cone 400, the control generation circuit 500, and the control signal wires 600 connecting the logic cone 400 with the control signal generation circuit 500 on the grid (not illustrated). In FIG. 30, the upper limit to the number of the control signal wires 600 vertically placeable per square on the grid is set to four. The control signal generation circuit 500 is a 6-bit (X=6) decoder.

First, the calculation unit 111b generates a triangle I1 having a selector 370 as an angle in the first stage (m=1) from the input-side FFs 380 and two input-side FFs 380 as the other angles that are connected to the selector 370 and serve as the highest-positioned and the lowest-positioned input-side FFs 380, respectively (steps S181 and S182 in FIG. 16).

This selector 370 located in the first stage from the input-side FFs 380 is not a selector connected to the output-side FF 300 (step S183 in FIG. 16). Therefore, next, the calculation unit 111b generates a triangle I2 having a selector 372 as an angle located in the second stage (m=2) from the input-side FFs 380 and two input-side FFs 380 as the other angles that are connected to the selector 372 and that serve as the highest-positioned and the lowest-positioned input-side FFs 380, respectively (steps S184, S181, and S182 in FIG. 16).

The calculation unit 111b repeats such processing and generates triangles I3 to I6. The triangle I6 has, as one of the angles thereof, the selector 310 connected to the output-side FF 300. FIG. 30 only illustrates the triangles I1, I2, and I4 of the triangles I1 to I6.

Next, the calculation unit 111b performs processing for generating the triangle O1 having the selector 310 as angle located in the first stage (n=1) from the output-side FF 300 in a side of the triangle O1 (steps S185 and S186 in FIG. 16). However, since there is only one selector 310 in the first stage from the output-side FF 300, no triangle corresponding to the triangle O1 is generated.

The selector 310 located in the first stage from the output-side FF 300 is not a selector connected to any of the input-side FFs 380 (step S187 in FIG. 16). Thus, next, the calculation unit 111b generates a triangle O2 having, as the angles, the output-side FF 300 and two second-stage (n=2) selectors 330 connected to the output-side FF 300 (step S188, S186, and S187 in FIG. 16).

The calculation unit 111b repeats such processing and generates triangles O3 to O6. The triangle O6 has the highest-positioned and the lowest-positioned selectors 370 that are connected to corresponding input-side FFs 380 and that serve as two of the angles of the triangle O6. FIG. 30 only illustrates the triangles O2 and O3 of the triangles O1 to O6.

After generating the triangles I1 to I6 and the triangles O1 to O6 as described above, the calculation unit 111b calculates the area of each of the triangles. The calculation unit 111b calculates an area ratio between an area A [I1] of the triangle I1 and an area A [O6] of the triangle O6. The triangle O6 has a selector 370 that serves as an angle of the triangle I1 in a side of the triangle I1 (steps S191 and S192 in FIG. 17). Next, the calculation unit 111b determines whether the obtained area ratio matches a predetermined area ratio (step S200 in FIG. 17).

If the area ratio between the area A [I1] and the area A [O6] does not match the predetermined area ratio, the calculation unit 111b calculates an area ratio between an area A [I2] of the triangle I2 and an area A [O5] of the triangle O5. The triangle O5 has a selector 372 that serves as an angle of the triangle I2 in a side of the triangle O5 (steps S210, S191, and S192 in FIG. 17). The calculation unit 111b determines whether the area ratio between the area A [I2] and the area A [O5] matches the predetermined area ratio (step S200 in FIG. 17).

In the same way, the calculation unit 111b performs the calculation and comparison of the area ratio between the triangles I3 and O4, the triangles I4 and O3, the triangles I5 and O2, and the triangles I6 and O1 until a combination of triangles whose area ratio matches the predetermined area ratio is obtained. In this example, the area A [O1] is set to 0 for processing.

As a result of the processing described above, the calculation unit 111b obtains information about the combination of the triangles Im and On whose area ratio matches the predetermined area ratio and information about the selector stage (a value of m) serving as a border between the triangles Im and On whose area ratio matches the predetermined area ratio. The calculation unit 111b sends the obtained information to the setting unit 111c. For example, if the area ratio between the triangle I4 (m=4) and the triangle O3 (n=3) matches the predetermined area ratio of 1:1, the calculation unit 111b determines that the selector stage serving as the border between the triangles I4 and O3 is m=4 (or n=3) and completes the processing of SF11 in FIG. 17.

In this embodiment, the triangles I1 to I6 are generated before the triangles O1 to O6 are generated (SF10 in FIG. 16). Alternatively, the triangles O1 to O6 may be generated before the triangles I1 to I6 are generated. Further alternatively, a combination of triangles Im and On that share a logic cell located in a certain stage as an angle of the triangle Im and in a side of the triangle On may be generated sequentially.

In addition, in this embodiment, after the triangles I1 to I6 and the triangles O1 to O6 are generated, an area ratio between two triangles sharing a logic cell in a certain stage as an angle of the triangle Im and in a side of the triangle On is calculated (SF11 in FIG. 17). Alternatively, while such two triangles Im and On sharing a logic cell in a certain stage as an angle of the triangle Im and in a side of the triangle On are being generated, an area ratio between the two triangles may be calculated. In this way, there are cases where a matching combination is obtained before generating all the triangles I1 to I6 and O1 to O6 and calculating the respective area ratios. Thus, in such cases, the amount of processing is reduced.

After obtaining the information about the logic cell stage serving as the border between the triangles Im and On whose area ratio matches the predetermined area ratio as described above, the setting unit 111c of the LSU setting processing unit 111 (in FIG. 3) uses the logic cell stage as a logical division stage and divides the control signal generation circuit in the first layout (step S220 in FIG. 5). The setting unit 111c arranges the divided control signal generation circuits (first and second control signal generation circuit portions) on the grid (steps S230 and S240 in FIG. 5).

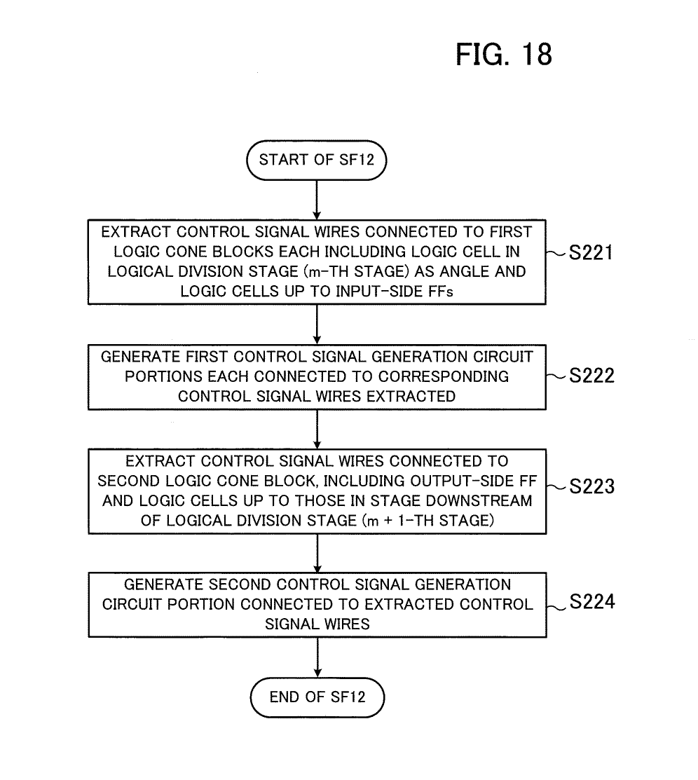

In step S220, the setting unit 111c performs processing illustrated in SF12 in FIG. 18.

Namely, first, the setting unit 111c extracts the control signal wires connected to first logic cone blocks, each of which is obtained by tracing the logic cells from the logical division stage to the stage of the input-side FFs (or from the stage of the input-side FFs to the logical division stage) (step S221 in FIG. 18).

Next, in accordance with SF7 in FIG. 13, the setting unit 111c generates circuit portions (first control signal generation circuit portions), each of which is to be connected to some of the control signal wires extracted from the undivided control signal generation circuit in step S221 (step S222 in FIG. 18).

The setting unit 111c also extracts the control signal wires connected to a second logic cone block, which is obtained by tracing the logic cells from the stage of the output-side FF(s) to the logic cell stage downstream of the logical division stage (or from the logic cell stage downstream of the logical division stage to the stage of the output-side FF(s) (step S223 in FIG. 18).

Next, in accordance with SF7 in FIG. 13, the setting unit 111c generates a circuit portion (a second control signal generation circuit portion) to be connected to some of the control signal wires extracted in step S223 from the undivided control signal generation circuit (step S224 in FIG. 18).

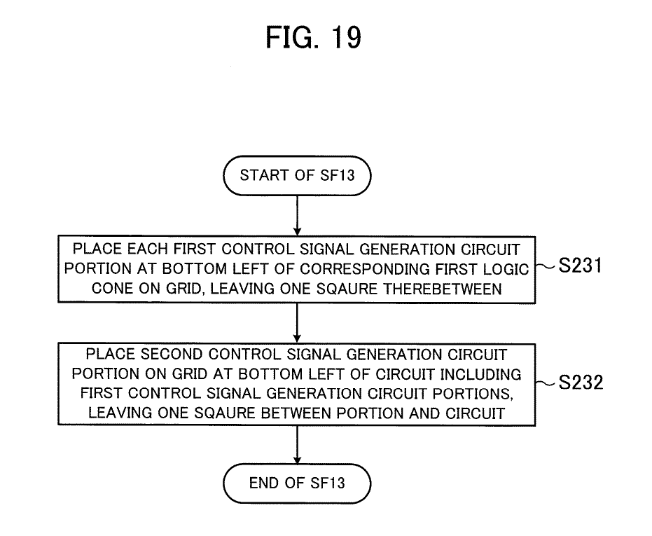

In the following step S230, the setting unit 111c performs processing as illustrated in SF13 in FIG. 19.

Namely, the setting unit 111c places each of the generated first control signal generation circuit portions at the bottom left of a corresponding first logic cone block on the grid, leaving one square between the first control signal generation circuit portion and the first logic cone block (step S231 in FIG. 19).

The setting unit 111c places the generated second signal generation circuit portion after the first control signal generation circuit portions are arranged as described in step S231, namely, at the bottom left of a region that includes the first logic cone blocks and the first control signal generation circuit portions on the grid, leaving one square between the region and the second signal generation circuit portion (step S232 in FIG. 19).

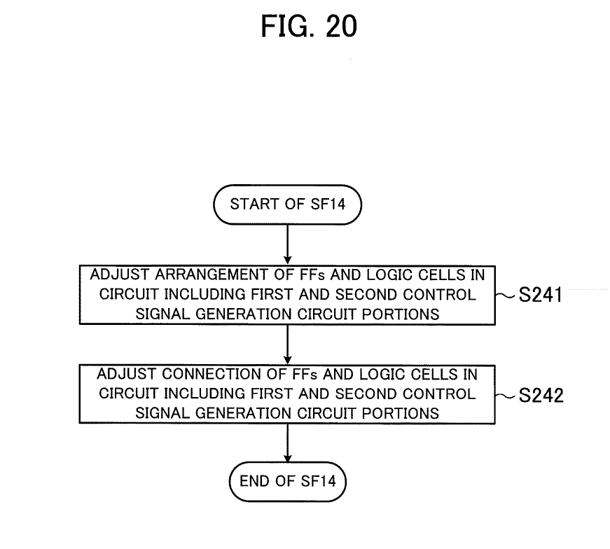

In the following step S240, the setting unit 111c performs processing as illustrated in SF14 in FIG. 20.

Namely, the setting unit 111c adjusts the arrangement and connection of the input-side FFs, the logic cells, and the output-side FF(s) in the circuit in which the first control signal generation circuit portions and the second control signal generation circuit portion have been arranged (steps S241 and S242 in FIG. 20). In this processing, the setting unit 111c performs relevant adjustments on the arrangement and connection of the input-side FFs, the logic cells, and the output-side FF(s) so that all the processing up to SF9 in FIG. 15 is satisfied.

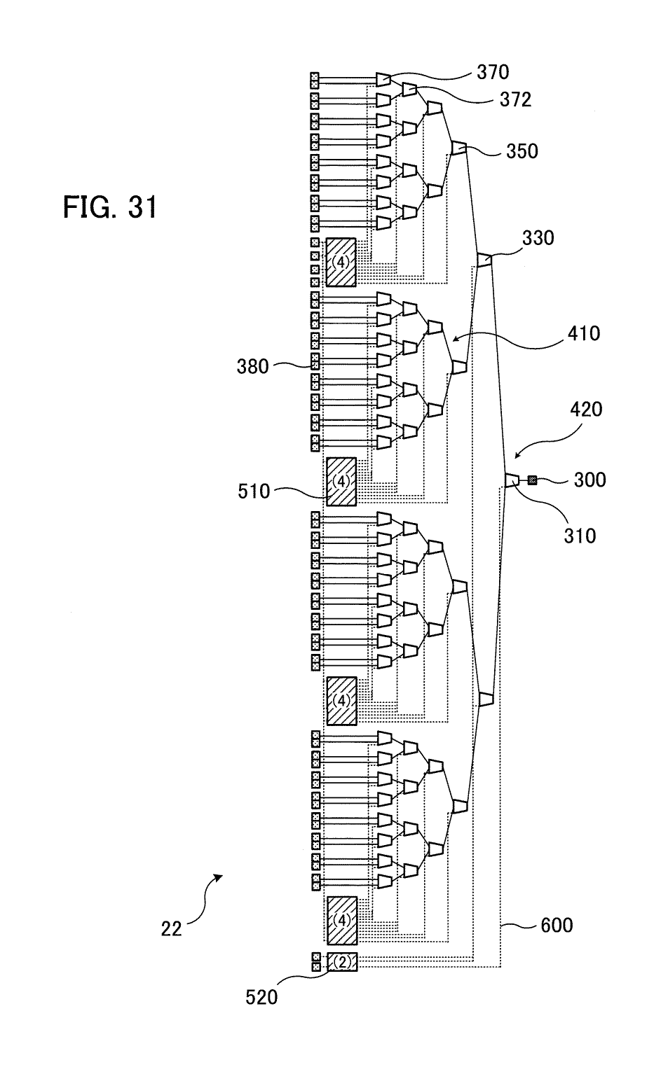

The above division of the control signal generation circuit and arrangement of the divided circuits will be described by using the 64-input 1-output selector circuit as an example, with reference to FIG. 31. FIG. 31 illustrates an exemplary layout (a second layout 22) in which the control signal generation circuit has been divided and the divided circuits have been arranged.

For example, if the area ratio between the triangle 14 (m=4) and the triangle O3 (n=3) in FIG. 30 matches the predetermined ratio as described above, the selector stage (m=4) serving as the border between the triangles I4 and O3 is determined as the logical division stage.

The setting unit 111c extracts the control signal wires 600 connected to first logic cone blocks 410 each of which is obtained by tracing a selector 350 located in the logical division stage to the corresponding input-side FFs 380 (step S221 in FIG. 18).

In accordance with SF7 in FIG. 13, the setting unit 111c generates first control signal generation circuit portions 510 to be connected to the extracted control signal wires 600 (step S222 in FIG. 18). In this example, the setting unit 111c generates the first control signal generation circuit portions 510, each of which is a 4-bit decoder, from the control signal generation circuit 500, which is a 6-bit decoder, as illustrated in FIG. 30. Each first control signal generation circuit portion 510 is to be connected to a first logic cone block 410, which includes input-side FFs 380 and the selectors placed over the four stages, as illustrated in FIG. 31.

The setting unit 111c also extracts the control signal wires 600 connected to a second logic cone block 420 obtained by tracing from the output-side FF 300 to the selectors 330 immediately downstream of the logical division stage (step S223 in FIG. 18).

In accordance with SF7 in FIG. 13, the setting unit 111c generates a second control signal generation circuit portion 520 to be connected to some of the extracted control signal wires 600 (step S224 in FIG. 18). In this example, the setting unit 111c generates the second control signal generation circuit portion 520 from the control signal generation circuit 500, which is a G-bit decoder, as illustrated in FIG. 30. The second control signal generation circuit portion 520, which is a 2-bit decoder, is to be connected to the second logic cone block 420, which includes the output-side FF 300 and the selectors placed over the two stages, as illustrated in FIG. 31.

The setting unit 111c places each of the generated first control signal generation circuit portions 510 at the bottom left of a corresponding one of the first logic cone blocks 410 on the grid, leaving one square between the first control signal generation circuit portion 510 and the corresponding first logic cone block 410 (step S231 in FIG. 19). In this example, as illustrated in FIG. 31, since there are four selectors 350 in the logical division stage (m=4), four first logic cone blocks 410 are formed, each having a selector 350 as an angle thereof. The setting unit 111c places a first control signal generation circuit portion 510 at the bottom left of each of the first logic cone blocks 410.

The setting unit 111c places the generated second signal generation circuit unit 520 at the bottom left of the circuit including the first control signal generation circuit portions 510, namely, at the bottom left of a region that includes the first logic cone blocks 410 and the first control signal generation circuit portions 510 on the grid, leaving one square between the second signal generation circuit unit 520 and the region (step S232 in FIG. 19).

Next, the setting unit 111c moves and reconnects the input-side FFs 380, the selectors, and the output-side FF 300 in the circuit including the first control signal generation circuit portions 510 and the second control signal generation circuit portion 520 in accordance with a specific rule (steps S241 and S242 in FIG. 20).

By performing steps S220 to S240, the second layout that includes the logic cone blocks and the control signal generation circuit portions (for example, the second layout 22 that includes the first and second logic cone blocks 410 and 420 and the first and second control signal generation circuit portions 510 and 520 in FIG. 31) is generated and arranged on the grid. Information about the second layout is stored in a storage unit (a memory or the like) in the designing apparatus 100, for example.

After generating the second layout by generating and arranging the first and second control signal generation circuit portions (including the division of the control signal generation circuit) as described above, the setting unit 111c performs the following processing.

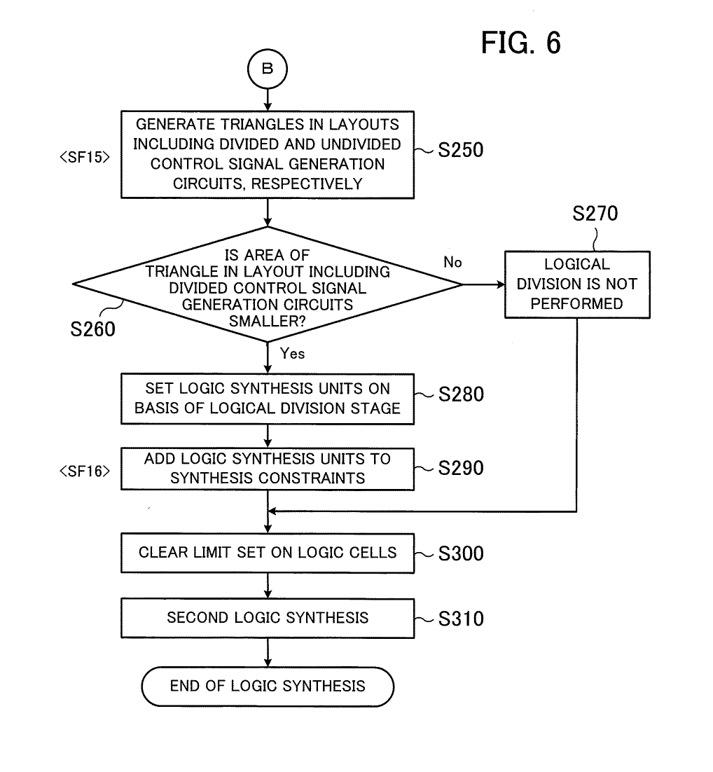

Namely, the setting unit 111c compares an area of a triangle formed in the first layout that includes the undivided control signal generation circuit with an area of a triangle formed in the second layout that includes the first and second control signal generation circuit portions generated by dividing the control signal generation circuit (steps S250 and S260 in FIG. 6).

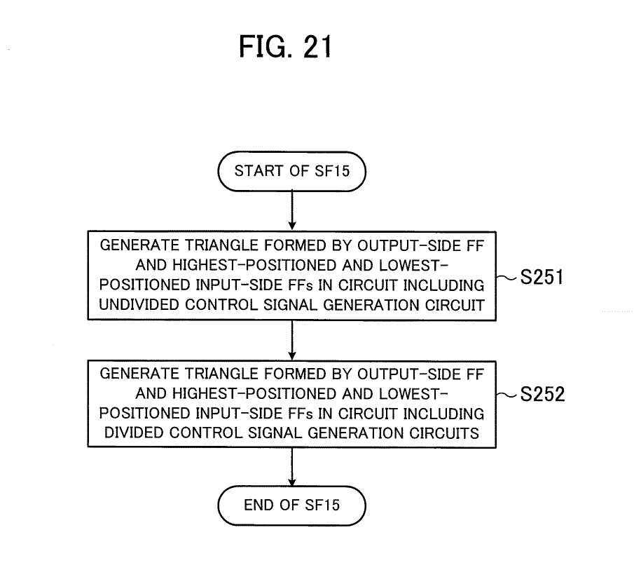

In step S250, the setting unit 111c performs processing as illustrated in SF15 in FIG. 21.

The setting unit 111c generates a triangle having the output-side FF (if a plurality of output-side FFs is placed, any one of the output-side FFs) as an angle and the highest-positioned and the lowest-positioned input-side FFs as the other angles in the first layout that includes the undivided control signal generation circuit (step S251 in FIG. 21).

The setting unit 111c generates a triangle having the output-side FF (if a plurality of output-side FFs is placed, any one of the output-side FFs) as an angle and the highest-positioned and the lowest-positioned input-side FFs as the other angles in the second layout that includes the first and second control signal generation circuit portions generated by dividing the control signal generation circuit (step S252 in FIG. 21).

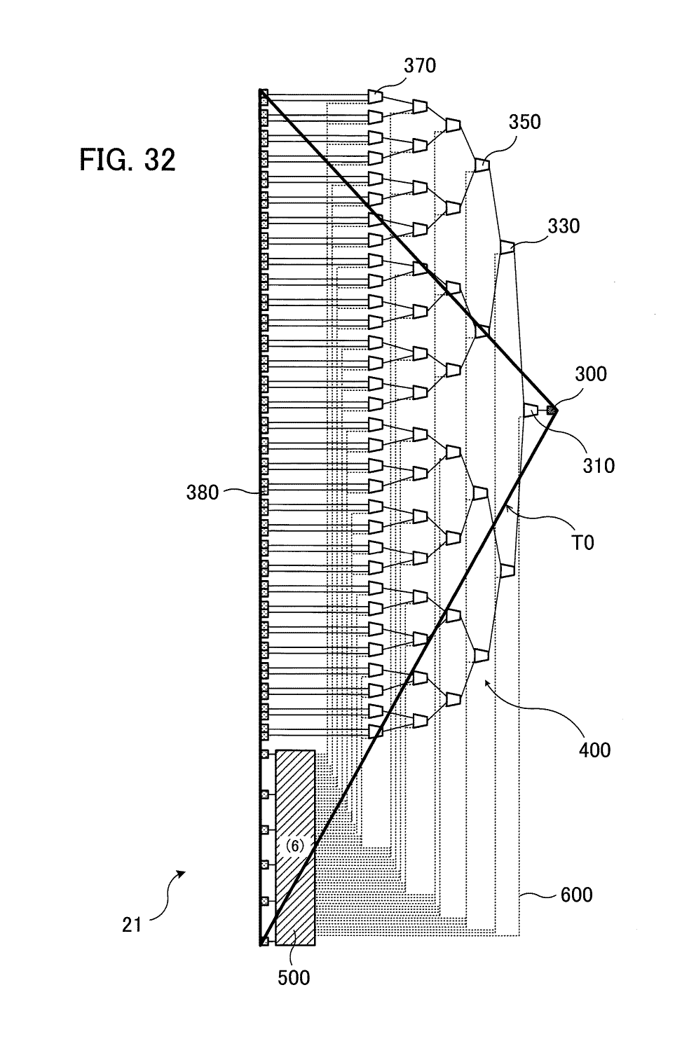

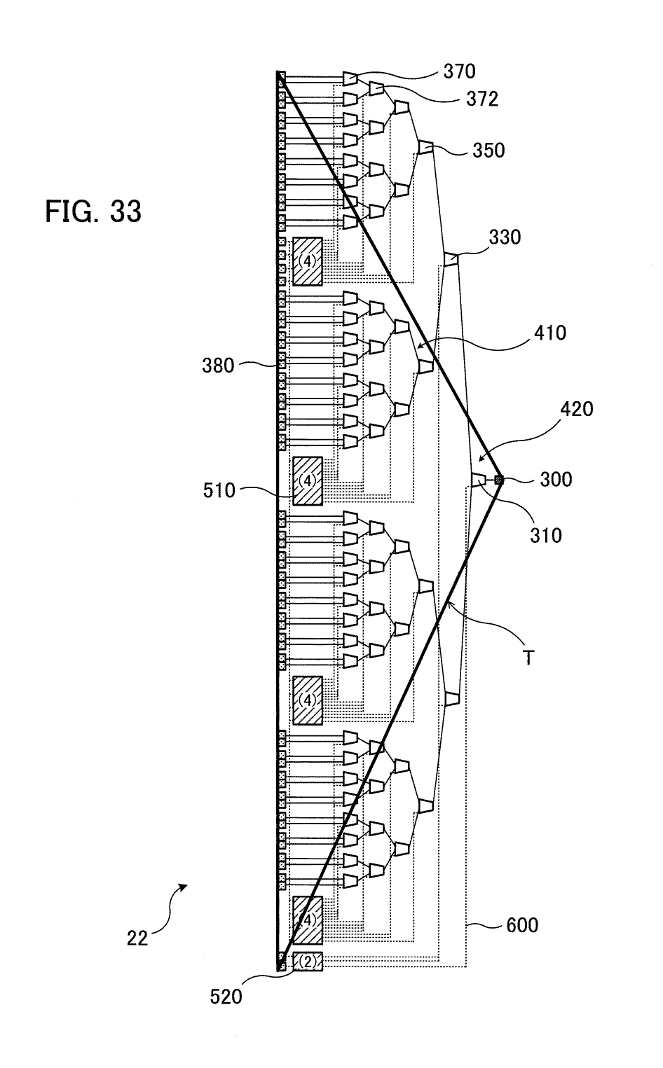

The above triangles will be described by using the 64-input 1-output selector circuit as an example, with reference to FIGS. 32 and 33.

As illustrated in FIG. 32, the setting unit 111c generates a triangle T0 in the first layout 21 that includes the logic cone 400 and the undivided control signal generation circuit 500 (a 6-bit decoder) connected to the logic cone 400 with the control signal wires 600. In the first layout 21 in FIG. 32, the triangle T0 has the single output-side FF 300 as an angle, the highest-positioned input-side FF 380 as an angle connected to one of the selectors 370, and the lowest-positioned input-side FF 380 as the other angle connected to the control signal generation circuit 500.

As illustrated in FIG. 33, the setting unit 111c generates a triangle T in the second layout 22 that includes the first and second logic cone blocks 410 and 420 and the first and second control signal generation circuit portions 510 and 520 (4-bit decoders and a 2-bit decoder) connected to the first and second logic cone blocks 410 and 420, respectively, with the control signal wires 600. In the second layout 22 in FIG. 33, the triangle T has the single output-side FF 300 as an angle, the highest-positioned input-side FF 380 as an angle connected to one of the selectors 370, and the lowest-positioned input-side FF 380 as the other angle connected to the control signal generation circuit portion 520.

As described above, in step S250, the setting unit 111c generates a triangle in the first layout including the undivided control signal generation circuit and a triangle in the second layout including the divided control signal generation circuits.

Next, the setting unit 111c calculates the area of each of the triangles and compares the sizes between the triangles (step S260 in FIG. 6). If the calculated area of the triangle formed in the second layout including the divided control signal generation circuits is smaller than that of the triangle formed in the first layout including the undivided control signal generation circuit, the setting unit 111c divides the logic at the above logical division stage and sets logic synthesis units (steps S270 and S280 in FIG. 6).

For example, in the 64-input 1-output selector circuit in FIGS. 32 and 33, the setting unit 111c calculates and compares the areas between the triangle T0 in the first layout 21 illustrated in FIG. 32 and the triangle T in the second layout 22 illustrated FIG. 33. In this example, the area of the triangle T0 in the first layout 21 (in FIG. 32) is 192×45/2=4320 (in arbitrary unit) and the area of the triangle T in the second layout 22 (in FIG. 33) is 200×34/2=3400 (in arbitrary unit).

If, as with the above case, the area of the triangle T is smaller than that of the triangle T0, the setting unit 111c divides the logic at the logical division stage, namely, at the 4th stage (m=4) from the input-side FFs 380. The 4th stage is the stage in which the selectors 350 are located. The setting unit 111c sets the first logic cone blocks 410 and the second logic cone block 420 illustrated in FIG. 33, which are divided by the logical division stage, as logic synthesis units to be used when logic synthesis is performed. Alternatively, the setting unit 111c may set the first logic cone blocks 410 and the first control signal generation circuit portions 510 connected thereto and the second logic cone block 420 and the second control signal generation circuit portion 520 connected thereto as logic synthesis units to be used when logic synthesis is performed.

If the area of the triangle T is larger than that of the triangle T0, the setting unit 111c does not divide the logic. In such case (step S270 in FIG. 6), the processing proceeds to step S300.

After setting the logic synthesis units as described above, the setting unit 111c adds the set logic synthesis units to the synthesis constraints 4 (step S290 in FIG. 6).

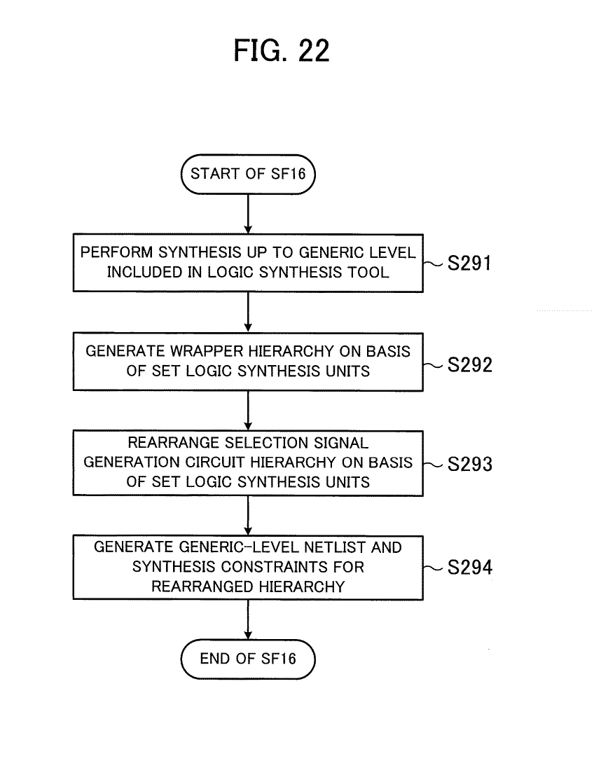

In step S290, the setting unit 111c performs processing as illustrated in SF16 in FIG. 22.

Namely, first, the setting unit 111c performs synthesis up to the basic cell structure (a generic level) included in the logic synthesis tool (step S291 in FIG. 22).

The setting unit 111c generates a wrapper hierarchy on the basis of the set logic synthesis units (step S292 in FIG. 22) and rearranges the selection signal generation circuit hierarchy of the selectors (step S293 in FIG. 22).

The setting unit 111c generates a generic-level netlist and synthesis constraints for the rearranged hierarchy (step S294 in FIG. 22).

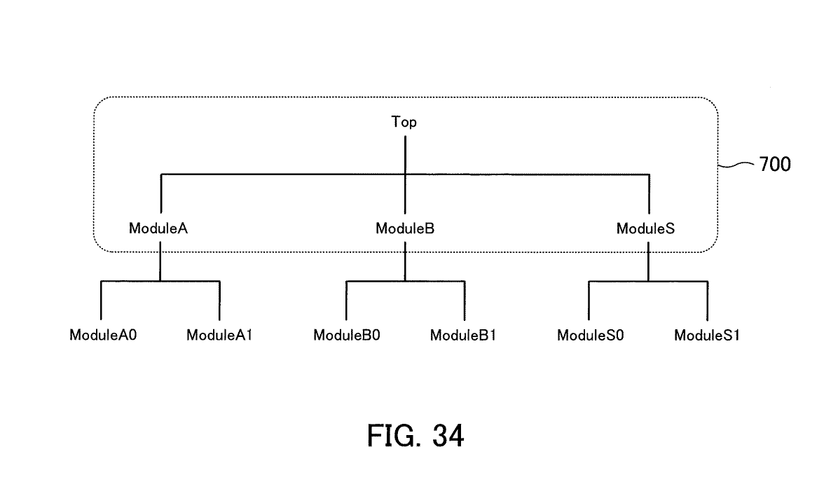

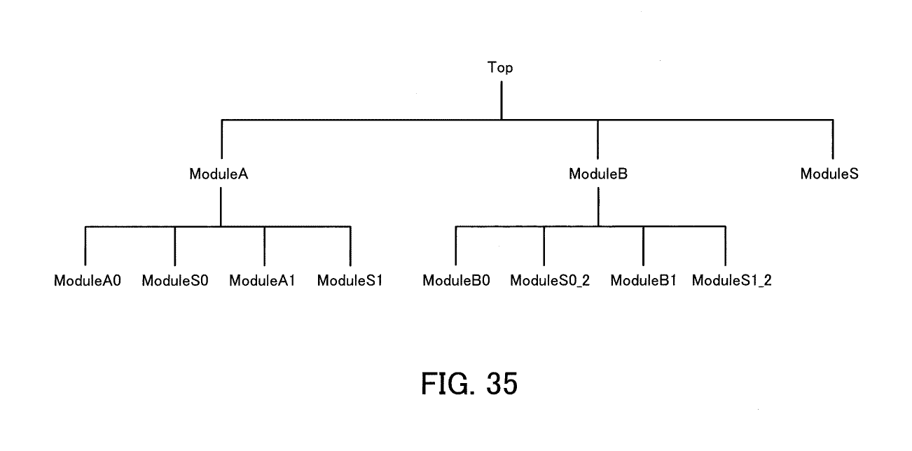

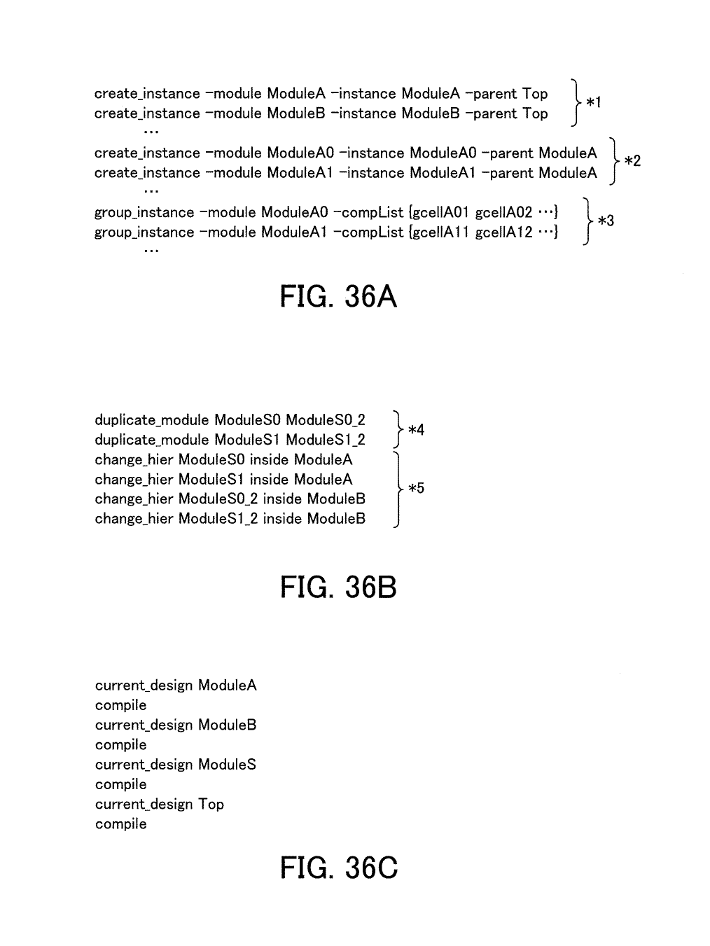

The following example will be described assuming that the processing up to step S280 has been performed and a logic synthesis unit 700 (Top, ModuleA, ModuleB, and ModuleS) has been set as illustrated in FIG. 34. Next, the setting unit 111c generates a wrapper hierarchy on the basis of the logic synthesis unit 700 (FIG. 34) and rearranges the selection signal generation circuit hierarchy so that a logical hierarchy as illustrated in FIG. 35 is generated. FIGS. 36A to 36C illustrate synthesis constraints obtained as a result of this processing.

FIG. 36A includes the following contents. The setting unit 111c creates ModuleA and ModuleB under Top (*1) and ModuleA0 and ModuleA1 under ModuleA (*2). Likewise, the setting unit 111c creates ModuleB0 and ModuleB1 under ModuleB. Next, the setting unit 111c groups gcellA01, gcellA02, etc., which are generic-level cells, under ModuleA0 (*3). Likewise, the setting unit 111c groups relevant generic-level cells under ModuleA1, ModuleB0, and Module B1, respectively.

FIG. 36B includes the following contents. The setting unit 111c duplicates ModuleS0 and ModuleS1 (*4). The setting unit 111c moves ModuleS0 and ModuleS1 to the inside of ModuleA and moves the duplicated ModuleS0_{—}2 and ModuleS1_{—}2 to the inside of ModuleB (*5).

The synthesis constraints representing the logic synthesis units are written as illustrated in FIG. 36C.

After generating the generic-level netlist and the synthesis constraints for the rearranged hierarchy (step S294 in FIG. 22), the setting unit 111c stores the generic-level netlist and the synthesis constraints in the logic synthesis tool. Next, the processing proceeds to the next step (steps S300 and S310).

After the logic synthesis units are set and the synthesis constraints 4 to which information about the logic synthesis units is added have been generated as described above, the logic synthesis processing unit 112 in the logic synthesis unit 110 (in FIG. 3) performs logic synthesis processing in accordance with the logic synthesis program 10 and generates the netlist 6. In these steps, the logic synthesis processing unit 112 clears the limit that has been set on the types of logic cells to be used, such as FFs and 2-input 1-output selectors (step S300 in FIG. 6), performs logic synthesis (second logic synthesis) by using the synthesis constraints 4 (step S310 in FIG. 6), and generates the netlist 6. Next, the wiring arrangement unit 120 (in FIG. 3) performs wiring arrangement processing by using the synthesis constraints 4, the netlist 6, etc. in accordance with the wiring arrangement program 11 and generates the wiring arrangement data 9.

As described above, the logic synthesis units are set by generating the logic cone with logic cells each having a basic logic structure, arranging the control signal wires in the logic cone in accordance with specific rules, arranging the logical cells, determining the logical division stage on the basis of certain triangles, and performing the logical division.

The set logic synthesis units are obtained by dividing the logic of the (whole or part of) design-target semiconductor integrated circuit. In the logic synthesis units, wires are arranged with less wire congestion. By using such logic synthesis units in wiring arrangement following logic synthesis, the possibility of occurrence of wire congestion is decreased.

In addition, as described above, if the logic is divided into logical synthesis units that enable arrangement of wires and if the area of the triangle including the divided control signal generation circuits is smaller than the area of the triangle before the division, the logical synthesis units are set. Thus, it is possible to reduce the possibility of an increase in layout area after the logic synthesis is performed by using such logic synthesis units and the wiring arrangement processing is reduced.

According to the above method, the logic synthesis units are set at the logic synthesis stage, the logic synthesis units suppressing occurrence of wire congestion and an increase in layout area at the wiring arrangement stage. As a result, repetition of the logic synthesis and the wiring arrangement is reduced. Thus, the efficiency of designing a semiconductor integrated circuit is improved.

For example, conventional logic synthesis places importance on timing and the total logic cell area in generating a netlist. When wiring arrangement is physically performed on a multi-input multi-output selection circuit, decoder circuit, encoder circuit, computing unit, or the like, even if the logic cell area (the total area or the total cell area) is small, wire congestion could still occur. In such case, generally, wire congestion is reduced by decreasing the circuit density. However, such method increases the layout area. If the logic synthesis units are reduced and each control circuit is divided, the logic cell area could be increased. However, wire congestion and an increase in layout area could be reduced in some cases. However, to obtain such logic synthesis units, logic synthesis and wiring arrangement processing needs to be repeated a number of times. In addition, logic synthesis and wiring arrangement processing needs to be repeated a few more times to determine whether the obtained logic synthesis units can reduce the layout area. Repeating such logic synthesis and wiring arrangement processing could decrease the designing efficiency.

In the above method, the logic synthesis units that suppress occurrence of wire congestion and an increase in layout area are set at the logic synthesis stage. In this way, repetition of logic synthesis and wiring arrangement processing for obtaining the logic synthesis units that suppress an increase in layout area is prevented. Thus, the designing efficiency is improved.

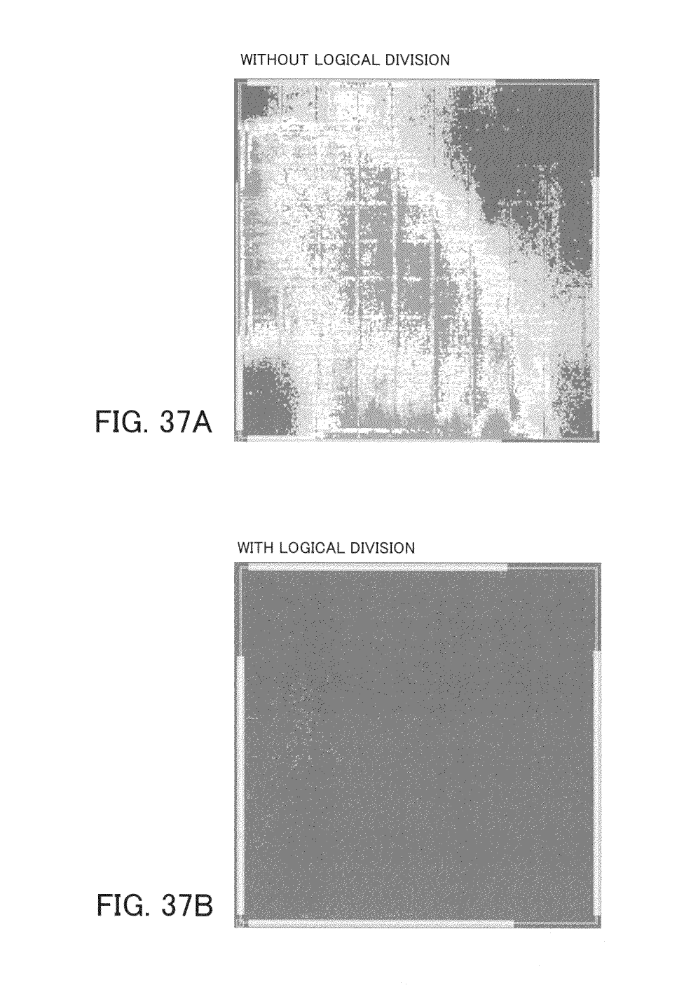

FIGS. 37A and 37B and TABLE 1 illustrate results of evaluations of wiring density after wiring arrangement processing.

TABLE 1

| | WITHOUT LOGICAL | WITH LOGICAL |
|---|---|---|
| | DIVISION | DIVISION |
| OVERFLOW NUMBER | 1665949 | 598 |
| MAXIMUM OVERFLOW | 30 | 3 |
| NUMBER | | |
| TOTAL LENGTH OF WIRES | 4183106.50 | 1242983.75 |

FIGS. 37A and 37B and TABLE 1 illustrate evaluation results obtained when two 4096-input 1-output selector circuits are arranged and wired. In FIGS. 37A and 37B and TABLE 1, a case in which wiring arrangement has been performed without the above logical division is represented as “without division” (FIG. 37A). A case in which wiring arrangement has been performed with the above logical division is represented as “with division” (FIG. 37B). In FIGS. 37A and 37B, occurrence of wire congestion is indicated with a light (pale) color.

FIGS. 37A and 37B and TABLE 1 indicate that occurrence of wire congestion and deterioration of wire characteristics caused by the wire congestion are effectively reduced by performing wiring arrangement with the above logical division.

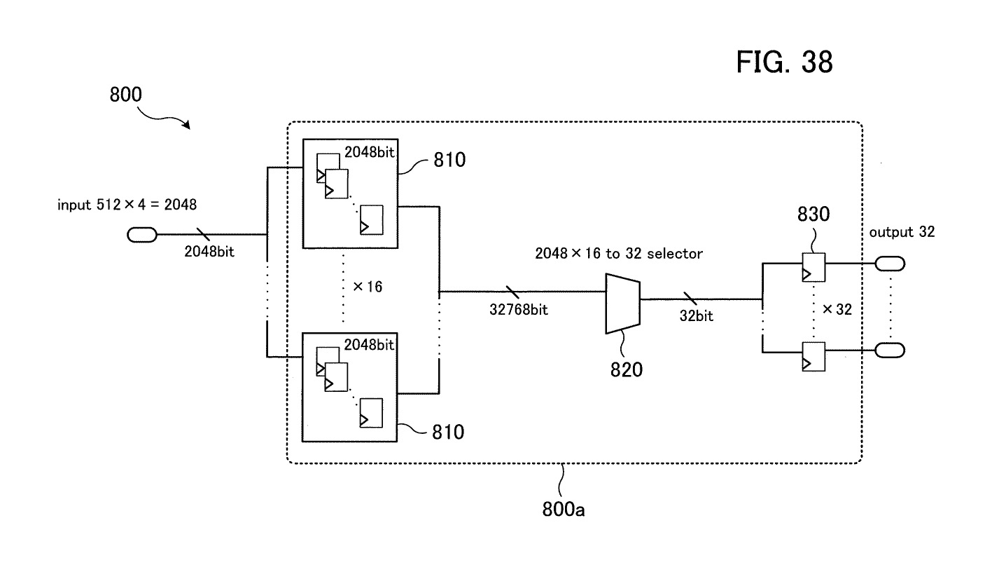

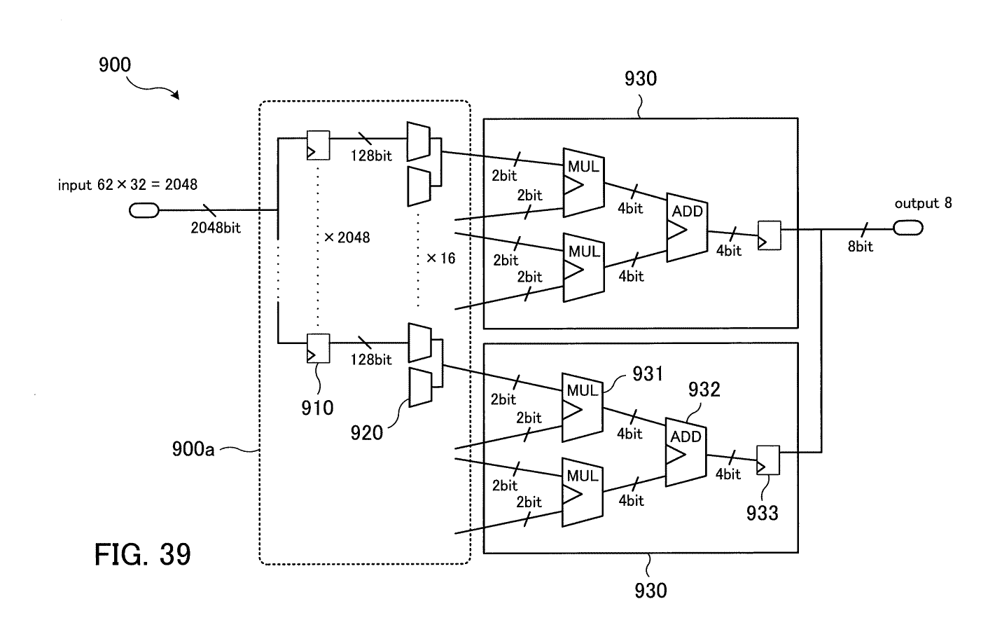

The above designing method using the designing apparatus 100 is applicable not only to the 64-input 1-output selector circuit used in the above example but to circuits as illustrated in FIGS. 38 and 39.

In a circuit 800 illustrated in FIG. 38, 2048-bit (=512×4) input is output via 16 RAM units 810 (16-bit RAM (FF)×128), a 32768-input (=2048×16) 32-output selector circuit 820, and 32 FFs 830. For example, the designing method using the above designing apparatus 100 is applicable to a range 800a of the circuit 800.

In a circuit 900 illustrated in FIG. 39, 2048-bit (=64×32) input is output in 8-bits, via 2048 FFs 910, 128-input 1-output selector circuits 920, and two multiply-accumulator units 930. Each of the multiply-accumulator units 930 includes two multipliers (MULs) 931, an adder (ADD) 932 connected to the MULs 931, and an FF 933 connected to the ADD 932. For example, the designing method using the above designing apparatus 100 is applicable to a range 900a of the circuit 900.

Processing functions of the above designing apparatus 100 may be realized by using a computer.

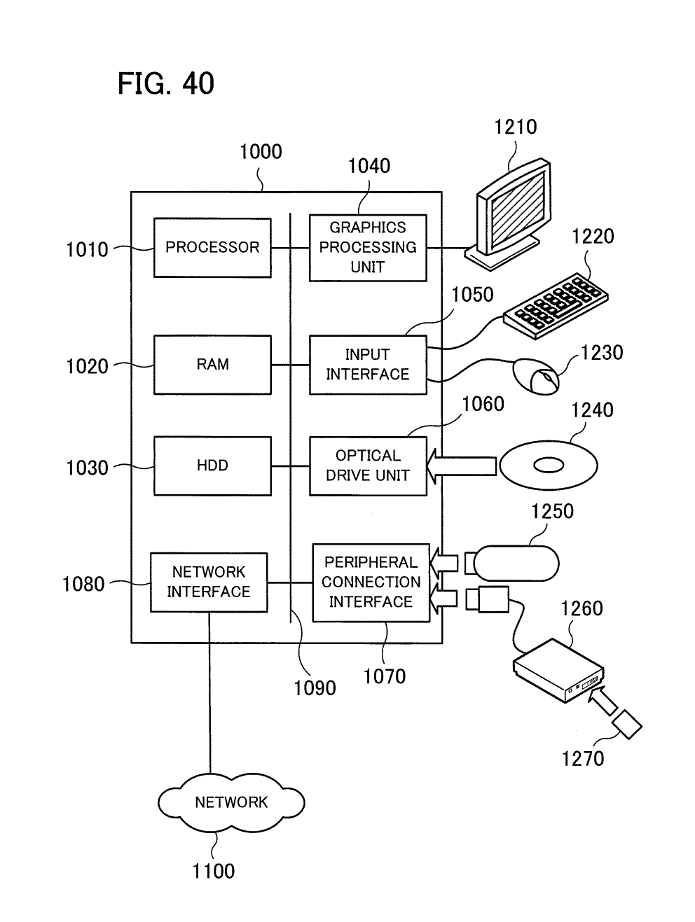

FIG. 40 illustrates an exemplary hardware configuration of the computer.

A computer 1000 is entirely controlled by a processor 1010. A random access memory (RAM) 1020 and a plurality of peripheral devices are connected to the processor 1010 via a bus 1090. The processor 1010 may be a multiprocessor. For example, the processor 1010 is a central processing unit (CPU), a micro processing unit (MPU), a digital signal processor (DSP), an application specific integrated circuit (ASIC), or a programmable logic device (PLD). The processor 1010 may be a combination of at least two of the following elements: a CPU, an MPU, a DSP, an ASIC, and a PLD.

The RAM 1020 is used as a main storage device of the computer 1000. At least a part of an operating system (OS) program or an application program executed by the processor 1010 is temporarily stored in the RAM 1020. In addition, various types of data needed for processing by the processor 1010 are stored in the RAM 1020.

Examples of the peripheral devices connected to the bus 1090 include a hard disk drive (HDD) 1030, a graphics processing unit 1040, an input interface 1050, an optical drive unit 1060, a peripheral connection interface 1070, and a network interface 1080.

The HDD 1030 magnetically writes and reads data in and from a disk therein. The HDD 1030 is used as an auxiliary storage device of the computer 1000. OS programs, application programs, and various types of data are stored in the HDD 1030. A semiconductor storage device such as a flash memory may be used as such auxiliary storage device.

The graphics processing unit 1040 is connected to a monitor 1210 and displays an image on a screen of the monitor 1210 in accordance with a command from the processor 1010. For example, a display device using a cathode ray tube (CRT) or a liquid crystal display device may be used as the monitor 1210.

The input interface 1050 is connected to a keyboard 1220 and a mouse 1230. The input interface 1050 forwards signals transmitted from the keyboard 1220 and the mouse 1230 to the processor 1010. The mouse 1230 is an example of a pointing device. Namely, a different pointing device may be used. Examples of such pointing device include a touch panel, a tablet, a touch pad, and a trackball.

The optical drive unit 1060 uses laser light or the like to read data recorded on an optical disc 1240. The optical disc 1240 is a portable recording medium in which data readable by optical reflection is recorded. Examples of the optical disc 1240 include a digital versatile disc (DVD), a DVD-RAM, a compact disc read only memory (CD-ROM), and a compact disc recordable (CD-R)/rewritable (RW).

The peripheral connection interface 1070 is a communication interface for connecting a peripheral device to the computer 1000. For example, a memory device 1250 and a memory reader and writer 1260 may be connected to the peripheral connection interface 1070. The memory device 1250 is a recording medium capable of communicating with the peripheral connection interface 1070. The memory reader and writer 1260 is a device for writing and reading data in and from a memory card 1270. The memory card 1270 is a card-type recording medium.

The network interface 1080 is connected to the network 1100. The network interface 1080 exchanges data with other computers or communication devices via the network 1100.

The processing functions of the designing apparatus 100, such as the processing functions of the logic synthesis unit 110, the LSU setting processing unit 111, the generation unit 111a, the calculation unit 111b, the setting unit 111c, and the wiring arrangement unit 120, are realized by using the hardware configuration as described above.

The computer 1000 realizes the processing functions of the designing apparatus 100 by executing a program recorded in a computer-readable recording medium, for example. The program holding the processing contents executed by the computer 1000 may be recorded in various types of recording media. For example, the program executed by the computer 1000 may be stored in the HDD 1030. The processor 1010 loads at least a part of the program stored in the HDD 1030 onto the RAM 1020 and executes the program. The program executed by the computer 1000 may be recorded in a portable recording medium such as the optical disc 1240, the memory device 1250, the memory card 1270, or the like. The program stored in such a portable recording medium is installed to the HDD 1030 in accordance with a control operation by the processor 1010 or the like so that the processor 1010 is allowed to execute the program. The processor 1010 may execute the program by reading the program directly from the portable recording medium.

According to the disclosed technique, the logic synthesis and wiring arrangement are efficiently performed by suppressing occurrence of wire congestion and an increase in layout area and reducing repetition of the logic synthesis and wiring arrangement processing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A designing apparatus comprising:
a processor configured to perform a procedure including:
generating a logic cone;
calculating an area ratio between a first triangle, which has a cell as an angle located in a certain stage between an input stage and an output stage in the logic cone and two cells as the other angles located at both ends in the input stage, each of the two cells being connected to an input of the cell located in the certain stage, and a second triangle, which has a cell as an angle located in the output stage and two cells as the other angles located at both ends in the certain stage, each of the two cells being connected to an input of the cell located in the output stage;
setting, when the area ratio matches a desired ratio, a first logic cone block between the certain stage and the input stage and a second logic cone block between the certain stage and the output stage as logic synthesis units; and
performing logic synthesis by using the logic synthesis units.

2. The designing apparatus according to claim 1,
wherein the generating a logic cone includes generating a first layout that includes the logic cone and a circuit connected to the logic cone, and
wherein the calculating is performed on the logic cone in the first layout.

3. The designing apparatus according to claim 2,
wherein the setting includes:
generating a second layout in which the circuit is divided into a first circuit portion and a second circuit portion that are connected to the first logic cone block and the second logic cone block, respectively;
comparing an area of a third triangle, which has a cell as an angle located in the output stage and two cells as the other angles located at both ends of the input stage in the first layout, with an area of a fourth triangle, which has a cell as an angle located in the output stage and two cells as the other angles located at both ends of the input stage in the second layout; and
setting, when the area of the fourth triangle is smaller than that of the third triangle, the first logic cone block and the second logic cone block as the logic synthesis units.

4. The designing apparatus according to claim 1,
wherein the generating a logic cone includes:
generating a grid; and
arranging a group of cells in the logic cone on the grid so that at least one square is left between adjacent cells.

5. The designing apparatus according to claim 2,
wherein the generating a logic cone includes:
generating a grid;
arranging a group of cells in the logic cone on the grid so that at least one square is left between adjacent cells; and
generating the first layout by arranging the circuit adjacent to the logic cone on the grid so that at least one square is left between the circuit and the logic cone.

6. The designing apparatus according to claim 3,
wherein the generating a logic cone includes:
generating a grid;
arranging a group of cells in the logic cone on the grid so that at least one square is left between adjacent cells; and
generating the first layout by arranging the circuit adjacent to the logic cone on the grid so that at least one square is left between the circuit and the logic cone, and
wherein the setting includes:
generating the second layout by arranging the first circuit portion adjacent to the first logic cone block on the grid so that at least one square is left between the first circuit portion and the first logic cone and arranging the second circuit portion adjacent to a region that includes the first logic cone block and the first circuit portion on the grid so that at least one square is left between the second circuit portion and the region.

7. The designing apparatus according to claim 6,
wherein the generating a logic cone includes setting the number of squares that each cell in the logic cone occupies on the grid on the basis of a logic function of the each cell.

8. The designing apparatus according to claim 6,
wherein the generating a logic cone includes setting the number of squares that each cell of the logic cone occupies on the grid on the basis of the number of terminals and the number of transistors of the each cell.

9. The designing apparatus according to claim 6,
wherein the generating a logic cone includes arranging first signal wires that connect the logic cone and the circuit on squares available on the grid within a preset upper limit set as the number of wires placeable per square.

10. The designing apparatus according to claim 9,
wherein the generating a logic cone includes moving, when arranging the first signal wires, cells in the logic cone to other squares on the grid and arranging the first signal wires on squares made available by the moving.

11. The designing apparatus according to claim 6,
wherein the setting includes arranging second signal wires that connect the first logic cone block and the first circuit portion and third signal wires that connect the second logic cone block and the second circuit portion on squares available on the grid within a preset upper limit set as the number of wires placeable per square.

12. The designing apparatus according to claim 11,
wherein the setting includes moving, when arranging the second and third signal wires, cells in the first and second logic cone blocks to other squares on the grid and arranging the second and third signal wires on squares made available by the moving.

13. The designing apparatus according to claim 1,
wherein the generating a logic cone includes using preset types of logic cells, and
wherein the logic synthesis is performed after the setting of the types is cleared.

14. The designing apparatus according to claim 1,
wherein the setting includes generating synthesis constraints including the logic synthesis units, and
wherein the logic synthesis is performed by using the synthesis constraints.

15. The designing apparatus according to claim 1,
wherein the processor further performs processing for wiring arrangement by using a netlist generated by the logic synthesis.

16. A designing method comprising:
generating, by a processor, a logic cone;
calculating, by the processor, an area ratio between a first triangle, which has a cell as an angle located in a certain stage between an input stage and an output stage in the logic cone and two cells as the other angles located at both ends in the input stage, each of the two cells being connected to an input of the cell located in the certain stage, and a second triangle, which has a cell as an angle located in the output stage and two cells as the other angles located at both ends in the certain stage, each of the two cells being connected to an input of the cell located in the output stage;
setting, by the processor, when the area ratio matches a desired ratio, a first logic cone block between the certain stage and the input stage and a second logic cone block between the certain stage and the output stage as logic synthesis units; and
performing, by the processor, logic synthesis by using the logic synthesis units.

17. A non-transitory computer-readable recording medium storing a computer program that causes a computer to perform a procedure comprising:
generating a logic cone;
calculating an area ratio between a first triangle, which has a cell as an angle located in a certain stage between an input stage and an output stage in the logic cone and two cells as the other angles located at both ends in the input stage, each of the two cells being connected to an input of the cell located in the certain stage, and a second triangle, which has a cell as an angle located in the output stage and two cells as the other angles located at both ends in the certain stage, each of the two cells being connected to an input of the cell located in the output stage;
setting, when the area ratio matches a desired ratio, a first logic cone block between the certain stage and the input stage and a second logic cone block between the certain stage and the output stage as logic synthesis units; and
performing logic synthesis by using the logic synthesis units.
